(19) United States
(12) Patent Application Publication
(10) Pub. No.: US 2026/0095324 A1
(43) Pub. Date: Apr. 2, 2026

(54) REUSABLE DESIGNATED VERIFIER NON-INTERACTIVE ZERO-KNOWLEDGE PROOFS FROM LOSSY TRAPDOOR FUNCTIONS

(71) Applicant: NTT Research, Inc., Sunnyvale, CA (US)

(72) Inventors: Riddhi Ghosal, Los Angeles, CA (US); Ilan Komargodski, Tel Aviv (IL); Brent Waters, Austin, TX (US)

(73) Assignee: NTT Research, Inc., Sunnyvale, CA (US)

(21) Appl. No.: 19/346,495

(22) Filed: Sep. 30, 2025

Related U.S. Application Data
(60) Provisional application No. 63/702,601, filed on Oct. 2, 2024.

(51) Int. Cl. H04L 9/30; H04L 9/06; H04L 9/32

(52) U.S. Cl. CPC H04L 9/3073; H04L 9/0643; H04L 9/0656; H04L 9/3218

(57) ABSTRACT

The present disclosure provides a method for secure attribute-based encryption with function hiding properties. The method comprises generating encryption parameters by sampling a hash function from a pairwise-independent hash family as a public parameter, generating trapdoor function pairs for each position and binary value, setting a public key as the set of trapdoor functions, generating a secret key comprising a binary string of specified length and trapdoor function inverses, and storing remaining trapdoor function inverses as a master secret key. The method further comprises receiving a message and attribute, encrypting the message under the attribute by sampling a random secret, generating shares using a share generating algorithm, computing ciphertext components for each position and binary value, computing a final ciphertext component using bitwise exclusive OR operation, assembling a complete ciphertext, and transmitting the complete ciphertext.

### CROSS-REFERENCE TO RELATED APPLICATION

This application claims the benefit of U.S. Provisional Application Ser. No. 63/702,601, filed Oct. 2, 2024, the content of which is incorporated by reference herein in its entirety, for all purposes.

### FIELD OF THE INVENTION

The present disclosure relates to cryptographic systems and methods, and more particularly to reusable designated verifier non-interactive zero-knowledge proofs constructed from lossy trapdoor functions.

### BACKGROUND OF THE INVENTION

Interactive proof systems enable a verifier with limited resources to decide an intractable language by communicating with a powerful but untrusted prover. Such systems guarantee soundness: the prover can only convince the verifier of true statements. An interactive proof is zero-knowledge according to standard definitions if additionally, the interaction reveals nothing beyond the validity of the statement. It is well known that at least one of the above security properties (soundness or zero-knowledge) must be computational, i.e., apply only to computationally-bounded attackers. Furthermore, zero-knowledge proofs must be interactive.

Blum, Feldman, and Micali showed that interaction may be avoided if the prover and the verifier share a common reference string (CRS) chosen by a trusted third party and given to both the prover and the verifier. They call this notion of proofs that consist of only a single message from the prover to the verifier non-interactive zero-knowledge (NIZK), and show that it is realizable in the CRS model under computational assumptions.

We know several “generic” constructions of NIZKs from other well-known cryptographic primitives. For instance, NIZKs are implied by (doubly-enhanced) trapdoor permutations, by circular-secure fully homomorphic encryption, and by strong KDM encryption. While we know how to instantiate (doubly-enhanced) trapdoor permutations from factoring, the other primitives are much less standard and we still do not have plain-model instantiation thereof from standard (and falsifiable) assumptions. NIZKs also exist in the Random Oracle Model (and without any additional assumption), which is generically uninstantiable in the plain model.

In contrast, we do have many known constructions from concrete algebraic assumptions, including the Diffie-Hellman assumption over bilinear groups, (sub-exponential) Decisional Diffie-Hellman, Learning with Errors (LWE), LPN and MQ, and more. While this is an impressive set of constructions, it is preferable to understand the generic relationship between NIZKs and other cryptographic primitives, allowing us to better position NIZKs in the hierarchy of cryptographic primitives. This modular approach to cryptographic research is crucial to the development of the theoretical foundations of cryptography.

We consider the well-known relaxation of NIZKs to the designated-verifier model (DV-NIZK). Here, a trusted third party generates a CRS together with a secret key, which is given (only) to the verifier and is used to verify proofs. We further consider by default the stronger notion of soundness for DV-NIZKs called reusable soundness, where soundness is held even if the scheme is used multiple times and a malicious prover can test whether the verifier accepts or rejects various proofs. (There is a seemingly weaker notion for DV-NIZKs called one-time soundness wherein soundness is guaranteed only for a single proof of a single statement. DV-NIZKs for NP with one-time soundness can be constructed from any public-key encryption scheme. Plain NIZKs are “automatically” reusable due to their public verifiability property.)

Our current understanding of DV-NIZKs for NP is quite different from that of NIZKs for NP. Specifically, Lombardi et al. gave a clean and modular construction of a DV-NIZK from generic assumptions: a public-key encryption scheme along with a KDM-secure secret-key encryption scheme. Both components can be instantiated under any of the CDH, LWE, or LPN assumptions. This compiler inherently results with an argument systems with computational soundness and computational zero-knowledge. Besides this compiler, all other DV-NIZK for NP constructions are tailored for a particular algebraic assumption, and we are not aware of any other construction of DV-NIZKs for NP from a generic “well accepted” primitive, except constructions that ultimately result with plain NIZK.

Improving our understanding of the minimal assumptions necessary for DV-NIZKs and their relationship to other cryptographic primitives remains an important goal in theoretical cryptography. New approaches to constructing DV-NIZKs generically from standard assumptions could provide valuable insights into the foundations of non-interactive zero-knowledge.

Existing cryptographic frameworks typically require organizations to choose between computational efficiency and advanced security properties such as designated verifier capabilities and statistical zero-knowledge guarantees. The absence of practical constructions that can provide reusable designated verifier non-interactive zero-knowledge proofs from standard assumptions has created a significant gap in the marketplace for cryptographic solutions that can support complex verification requirements while maintaining both security and operational efficiency. Therefore, there exists a substantial commercial need for attribute-based encryption systems that can deliver enhanced function hiding properties and support the construction of designated verifier zero-knowledge proofs suitable for real-world deployment.

### BRIEF SUMMARY OF THE INVENTION

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

In this work, we consider the relaxation of NIZKs to the designated-verifier model (DV-NIZK) and present a new framework for constructing (reusable) DV-NIZKs for NP generically from lossy trapdoor functions and PRFs computable by polynomial-size branching programs (a class that includes LOGSPACE). Previous “generic” constructions of DV-NIZK for NP relied either on (doubly-enhanced) trapdoor permutations or on a public-key encryption scheme plus a KDM-secure secret key encryption scheme. Notably, our DV-NIZK framework achieves statistical zero-knowledge. To the best of our knowledge, this is the first DV-NIZK construction from any “generic” standard assumption with statistical zero-knowledge that does not already yield a NIZK.

A key technical component of our construction is an efficient, unconditionally secure secret sharing scheme for non-monotone functions with randomness recovery for all polynomial-size branching programs. As an independent contribution we present an incomparable randomness recoverable (monotone) secret sharing for NC1 in a model with trusted setup that guarantees computational privacy assuming one-way functions. We believe that these primitives will be useful in related contexts in the future.

According to an aspect of the present disclosure, a method for secure attribute-based encryption with function hiding properties is provided. The method comprises generating encryption parameters using a processor by sampling a hash function H from a pairwise-independent hash family as a public parameter and storing the hash function H in a memory, generating a sequence of trapdoor function pairs

$$( {g}_{i , b} , {g}_{i , b}^{- 1} )$$

for i∈[n] and B∈{0, 1}, where n is a positive integer, and storing the trapdoor function pairs in the memory, setting a public key pk as the set of trapdoor functions {g_{i,b}}_{i∈[n],b∈{0,1}} and storing the public key pk in the memory, generating a secret key sk comprising a binary string ƒ of length n and a set of trapdoor function inverses

$${\{ {g}_{i , {f}_{i}}^{- 1} \}}_{i ∈ [ n ]} ,$$

where ƒᵢ is the i-th bit of ƒ, and storing the secret key sk in the memory, and storing remaining trapdoor function inverses as a master secret key in a memory. The method further comprises receiving, via a network interface device, a message m to be encrypted and an attribute x, and storing the message m and the attribute a in the memory. The method also comprises encrypting the message m under the attribute a using the processor by sampling a random secret s and storing the random secret s in the memory, generating shares (a_{1,0}, a_{1,1}, . . . , a_{n,0}, a_{n,1}) using a share generating algorithm executed by the processor and storing the generated shares in the memory, computing ciphertext components ct_{i,b}=g_{i,b}(a_{i,b}) for i∈[n] and b∈{0, 1} using the processor and storing the ciphertext components in the memory, and computing a final ciphertext component ct₀=m⊕H(s), where ⊕ denotes bitwise XOR, and storing the final ciphertext component in the memory. The method additionally comprises assembling, using the processor, a complete ciphertext as (ct₀, {ct_{i,b}}_{i∈[n], b∈{0,1}}) and storing the complete ciphertext in a storage device, and transmitting the complete ciphertext via the network interface device.

According to other aspects of the present disclosure, the method may include one or more of the following features. The method may further comprise decrypting the computing shares

$${a}_{i , {f}_{i}} = {g}_{i , {f}_{i}}^{- 1} ( {ct}_{i , {f}_{i}} ) for all {g}_{i , {f}_{i}}^{- 1} ∈ sk ,$$

reconstructing the secret s using a secret sharing reconstruction procedure on the computed shares, and recovering the message as m=ct₀⊕H(s). The method may further comprise implementing function hiding properties, wherein an adversary with access to the complete ciphertext and the message cannot distinguish between two different implementations of encryption functions that produce the same input-output behavior. The method may further comprise executing a transformation to construct a designated verifier non-interactive zero knowledge proof, wherein one or more of the following properties are satisfied: the proof is designated for a specific verifier with a secret verification key, the proof consists of a single message from the prover to the designated verifier, the proof demonstrates knowledge of a witness for a statement without revealing any information about the witness beyond its existence, only the designated verifier possessing the secret verification key can validate the proof, the proof cannot be re-used or transferred to convince any other party of the statement's validity, the designated verifier cannot use the proof to convince others, maintaining zero-knowledge even if the verifier is malicious, or the transformation ensures that the resulting proof preserves the security properties of the original attribute-based encryption scheme while adding the designated verifier property. The trapdoor function pairs

$$( {g}_{i , b} , {g}_{i , b}^{- 1} )$$

may be generated using a lossy trapdoor function setup algorithm that ensures the trapdoor functions can be sampled efficiently in either a lossy or injective mode, and the trapdoor function pairs

$$( {g}_{i , b} , {g}_{i , b}^{- 1} )$$

may be computable and invertible in the injective mode with knowledge of the trapdoor. The share generating algorithm may implement a secret sharing scheme for non-monotone functions, allowing reconstruction of the secret s from an authorized subset of the shares, and the pairwise-independent hash family may be selected to ensure that the entropy of the random secret s given the ciphertext components is sufficiently high to prevent statistical attacks. The method may further comprise verifying the integrity of the computed shares by regenerating all the shares using the reconstructed secret s, applying the trapdoor functions g_{i,b} to the regenerated shares, and comparing the results with the original ciphertext components ct_{i,b}. The attribute x and the binary string ƒ may represent inputs to a function F(x, ƒ), and decryption succeeds if and only if F(x, ƒ)=1, thereby implementing attribute-based access control.

According to another aspect of the present disclosure, a system for secure attribute-based encryption with function hiding properties is provided. The system comprises a processor and a memory storing instructions that, when executed by the processor, cause the system to perform operations comprising generating encryption parameters by sampling a hash function H from a pairwise-independent hash family as a public parameter and storing the hash function H in the memory, generating a sequence of trapdoor function pairs

$$( {g}_{i , b} , {g}_{i , b}^{- 1} ) for i ∈ [ n ] and b ∈ \{ 0 , 1 \} ,$$

where n is a positive integer, and storing the trapdoor function pairs in the memory, setting a public key pk as the set of trapdoor functions {g_{i,b}}_{i∈[n],b∈{0,1}} and storing the public key pk in the memory, generating a secret key sk comprising a binary string ƒ of length n and a set of trapdoor function inverses

$${\{ {g}_{i , {f}_{i}}^{- 1} \}}_{i ∈ [ n ]} ,$$

where ƒᵢ is the i-th bit of ƒ, and storing the secret key sk in the memory, and storing remaining trapdoor function inverses as a master secret key in the memory. The operations further include receiving, via a network interface device, a message m to be encrypted and an attribute x, and storing the message m and the attribute a in the memory. The operations also include encrypting the message m under the attribute a by sampling a random secret s and storing the random secret s in the memory, generating shares (a_{1,0}, a_{1,1}, . . . , a_{n,0}, a_{n,1}) using a share generating algorithm and storing the generated shares in the memory, computing ciphertext components ct_{i,b}=g_{i,b} (a_{i,b}) for i∈[n] and b∈{0, 1} and storing the ciphertext components in the memory, and computing a final ciphertext component ct₀=m⊕H(s), where ⊕ denotes bitwise XOR, and storing the final ciphertext component in the memory. The operations additionally include assembling a complete ciphertext as (ct₀, {ct_{i,b}}i∈{[n], b∈}_{0,1}}) and storing the complete ciphertext in a storage device, and transmitting the complete ciphertext via the network interface device.

According to other aspects of the present disclosure, the system may include one or more of the following features. The operations may further comprise decrypting the complete ciphertext by computing shares

$${a}_{i , {f}_{i}} = {g}_{i , {f}_{i}}^{- 1} ( c {t}_{i , {f}_{i}} ) for all {g}_{i , {f}_{i}}^{- 1} ∈ s k ,$$

reconstructing the secret s using a secret sharing reconstruction procedure on the computed shares, and recovering the message as m=ct₀⊕H(s). The operations may further comprise implementing function hiding properties, wherein an adversary with access to the complete ciphertext and the message cannot distinguish between two different implementations of encryption functions that produce the same input-output behavior. The operations may further comprise executing a transformation to construct a designated verifier noninteractive zero knowledge proof, wherein one or more of the following properties are satisfied: the proof is designated for a specific verifier with a secret verification key, the proof consists of a single message from the prover to the designated verifier, the proof demonstrates knowledge of a witness for a statement without revealing any information about the witness beyond its existence, only the designated verifier possessing the secret verification key can validate the proof, the proof cannot be re-used or transferred to convince any other party of the statement's validity, the designated verifier cannot use the proof to convince others, maintaining zero-knowledge even if the verifier is malicious, or the transformation ensures that the resulting proof preserves the security properties of the original attribute-based encryption scheme while adding the designated verifier property.

The trapdoor function pairs

$$( {g}_{i , b} , {g}_{i , b}^{- 1} )$$

may be generated using a lossy trapdoor function setup algorithm that ensures the trapdoor functions can be sampled efficiently in either a lossy or injective mode, and the trapdoor function pairs

$$( {g}_{i , b} , {g}_{i , b}^{- 1} )$$

may be efficiently computable and invertible in the injective mode with knowledge of the trapdoor. The share generating algorithm may implement a secret sharing scheme for non-monotone functions, allowing reconstruction of the secret s from an authorized subset of the shares, and the pairwise-independent hash family may be selected to ensure that the entropy of the random secret s given the ciphertext components is sufficiently high to prevent statistical attacks. The operations may further comprise verifying the integrity of the computed shares by regenerating all the shares using the reconstructed secret s, applying the trapdoor functions g_{i,b} to the regenerated shares, and comparing the results with the original ciphertext components ct_{i,b}. The attribute a and the binary string ƒ may represent inputs to a function F(x, ƒ), and decryption succeeds if and only if F(x, ƒ)=1, thereby implementing attribute-based access control.

According to another aspect of the present disclosure, a non-transitory computer-readable storage medium storing instructions that, when executed by a processor, cause the processor to perform operations for secure attribute-based encryption with function hiding properties is provided. The operations comprise generating encryption parameters by sampling a hash function H from a pairwise-independent hash family as a public parameter and storing the hash function H in a memory, generating a sequence of trapdoor function pairs

$$( {g}_{i , b} , {g}_{i , b}^{- 1} ) for i ∈ [ n ] and b ∈ \{ 0 , 1 \} ,$$

where n is a positive integer, and storing the trapdoor function pairs in the memory, setting a public key pk as the set of trapdoor functions {g_{i,b}}_{i∈[n], b∈{0,1}} and storing the public key pk in the memory, generating a secret key sk comprising a binary string ƒ of length n and a set of trapdoor function inverses

$${\{ {g}_{i , {f}_{i}}^{- 1} \}}_{i ∈ [ n ]} ,$$

where ƒᵢ is the i-th bit of ƒ, and storing the secret key sk in the memory, and storing remaining trapdoor function inverses as a master secret key in a memory. The operations further include receiving, via a network interface device, a message m to be encrypted and an attribute x, and storing the message m and the attribute x in the memory. The operations also include encrypting the message m under the attribute a using the processor by sampling a random secret s and storing the random secret s in the memory, generating shares (a_{1,0}, a_{1,1}, . . . , a_{n,0}, a_{n,1}) using a share generating algorithm executed by the processor and storing the generated shares in the memory, computing ciphertext components ct_{i,b}=g_{i,b}(a_{i,b}) for i∈[n] and b∈{0, 1} using the processor and storing the ciphertext components in the memory, and computing a final ciphertext component ct₀=m ⊕H(s), where ⊕ denotes bitwise XOR, and storing the final ciphertext component in the memory. The operations additionally include assembling, using the processor, a complete ciphertext as (ct₀, {ctᵢ}_{i∈[n], B∈{0,1}}) and storing the complete ciphertext in a storage device, and transmitting the complete ciphertext via the network interface device.

According to other aspects of the present disclosure, the non-transitory computer-readable storage medium may include one or more of the following features. The operations may further comprise decrypting the complete ciphertext by computing shares

$${a}_{i , {f}_{i}} = {g}_{i , {f}_{i}}^{- 1} ( c {t}_{i , {f}_{i}} ) for all {g}_{i , {f}_{i}}^{- 1} ∈ sk ,$$

reconstructing the secret s using a secret sharing reconstruction procedure on the computed shares, and recovering the message as m=ct₀⊕H(s). The operations may further comprise executing a transformation to construct a designated verifier non-interactive zero knowledge proof, wherein one or more of the following properties are satisfied: the proof is designated for a specific verifier with a secret verification key, the proof consists of a single message from the prover to the designated verifier, the proof demonstrates knowledge of a witness for a statement without revealing any information about the witness beyond its existence, only the designated verifier possessing the secret verification key can validate the proof, the proof cannot be re-used or transferred to convince any other party of the statement's validity, the designated verifier cannot use the proof to convince others, maintaining zero-knowledge even if the verifier is malicious, or the transformation ensures that the resulting proof preserves the security properties of the original attribute-based encryption scheme while adding the designated verifier property. The trapdoor function pairs

$$( {g}_{i , b} , {g}_{i , b}^{- 1} )$$

may be generated using a lossy trapdoor function setup algorithm that ensures the trapdoor functions can be sampled efficiently in either a lossy or injective mode, the trapdoor function pairs

$$( {g}_{i , b} , {g}_{i , b}^{- 1} )$$

may be efficiently computable and invertible in the injective mode with knowledge of the trapdoor, the share generating algorithm may implement a secret sharing scheme for non-monotone functions, allowing reconstruction of the secret s from an authorized subset of the shares, and the attribute a and the binary string ƒ may represent inputs to a function F(x, ƒ), and decryption succeeds if and only if F(x, ƒ)=1, thereby implementing attribute-based access control.

The foregoing general description of the illustrative embodiments and the following detailed description thereof are merely exemplary aspects of the teachings of this disclosure and are not restrictive.

### BRIEF DESCRIPTION OF THE DRAWINGS

Non-limiting and non-exhaustive examples are described with reference to the following figures.

FIG. 1 illustrates a flowchart for a secure attribute-based encryption and decryption process, according to aspects of the present disclosure.

FIG. 2 depicts a block diagram of a communication system for secure data processing, according to aspects of the present disclosure.

FIG. 3 illustrates a flowchart for a method of secure attribute-based encryption with function hiding properties, according to aspects of the present disclosure.

FIG. 4 illustrates a flowchart for an encryption process method, according to aspects of the present disclosure.

FIG. 5 illustrates a flowchart for a decryption process method, according to aspects of the present disclosure.

FIG. 6 illustrates a flowchart for a method of executing and verifying designated verifier proofs, according to aspects of the present disclosure.

FIG. 7 illustrates a secure attribute-based encryption system with interconnected modules, according to aspects of the present disclosure.

FIG. 8 illustrates a client computing architecture with processing and storage subsystems, according to aspects of the present disclosure.

FIG. 9 illustrates a server-client network architecture with cloud services, according to aspects of the present disclosure.

### DETAILED DESCRIPTION

The following description sets forth exemplary aspects of the present disclosure. It should be recognized, however, that such description is not intended as a limitation on the scope of the present disclosure. Rather, the description also encompasses combinations and modifications to those exemplary aspects described herein.

A detailed description of systems, devices, and methods consistent with embodiments of the present disclosure is provided below. While several embodiments are described, it should be understood that disclosure is not limited to any one embodiment, but instead encompasses numerous alternatives, modifications, and equivalents. In addition, while numerous specific details are set forth in the following description in order to provide a thorough understanding of the embodiments disclosed herein, some embodiments can be practiced without some or all of these details. Moreover, for the purpose of clarity, certain technical material that is known in the related art has not been described in detail in order to avoid unnecessarily obscuring the disclosure.

We present a new framework for constructing (reusable) DV-NIZKs from generic assumptions. Our framework yields reusable DV-NIZKs generically from lossy trapdoor functions and PRFs in PBP. The class PBP stands for all functions computable by polynomial-size branching programs, a class that includes NC1 (and is equal to LOGSPACE). Our lossy trapdoor functions need to be length-parameterized, meaning that the output size is independent of the input size; such lossy trapdoor functions (and also the PRF) can be constructed from DDH or LWE. Our framework can be instantiated to result with computational soundness and statistical zero-knowledge.
Theorem 0.1 (Informal). Assuming the existence of a length-parametrized trapdoor lossy functions (see Definition [symbol] [symbol] ) and a PRF in PBP (PBP is the complexity class containing all functions that can be computed by polynomial sized branching programs (which includes LOGSPACE, and therefore NC1).), there exist reusable designated-verifier NIZK for NP with computational soundness and statistical zero-knowledge.

Technically, we build a form of an Attribute-Based Encryption (ABE) scheme, as defined in prior work, that is known to be equivalent to DV-NIZKs (assuming public-key encryption exists). Specifically, this notion of ABE is a single-key scheme satisfying a certain “function-hiding under decryption queries” property. While previous work built it from a public-key encryption scheme plus KDM-secure secret-key encryption scheme or Hinting PRG, we build it from lossy trapdoor functions and a PRF in PBP. As mentioned, our construction also has the added advantage of achieving statistical zero-knowledge, whereas the framework of prior work inherently results with computational soundness and ZK (due to their black-box usage of the single key ABE).

Secret sharing for non-monotone functions with randomness recovery. A key technical component in our construction is a secret sharing scheme with randomness recovery for all (even non-monotone) functions in PBP. A secret sharing scheme for nonmonotone functions (sometimes referred to as non-monotone secret sharing or conditional disclosure of secrets, as established in the literature) is a method for sharing a secret among n parties relative to a (not necessarily monotone) function F:{0,1}ⁿ →{0, 1}. The secret sharing scheme outputs 2n shares (s₁, t₁, s₂, t₂, . . . , sₙ, tₙ) and for any input (x₁, . . . , xₙ)∈{0, 1}ⁿ, as above, the collection of shares {sᵢ:xᵢ=1}∪{tᵢ:xᵢ=0} determines the secret if F(x₁, . . . , xₙ)=1 and does not reveal anything otherwise. The randomness recovery property provides a procedure that recovers all the 2n shares from any subset of <2n shares that are authorized according to F.

Our contribution in this context is an efficient secret sharing scheme with randomness recovery for all PBP; this scheme is unconditionally secure. Our scheme is obtained by adapting the well-known st-connectivity secret sharing scheme to handle all functions in PBP.
Theorem 0.2 (See Theorem 3.15). There exists an efficient secret sharing scheme with randomness recovery for all functions in PBP.

Secret sharing for non-monotone functions should be contrasted with “standard” secret sharing schemes that can only support monotone functions. Indeed, in a standard secret sharing scheme the n shares t₁, . . . , tₙ are essentially fixed to L, and so having xᵢ=1 can only increase the amount of information available to recover the secret. Interestingly, prior work studies the notion of “standard” secret sharing with randomness recovery and obtains three main results. First, every access structure admits a secret sharing scheme with randomness recovery (albeit inefficient). Second, even for very simple access structures, obtaining randomness recovery requires the use of one-way functions. Finally, they note that randomness recovery can be obtained for any NC1 access structure by using a onetime KDM-secure secret-key encryption (which they in turn base on a new assumption they call linear-resistant PRGs). Since our secret sharing scheme in Theorem 0.2 is unconditionally secure, we obtain an intriguing separation between “standard” secret sharing and secret sharing for non-monotone functions, both with randomness recovery.

Lastly, as an independent contribution we give a “standard” secret sharing scheme with randomness recovery for all monotone-NC1 from only one-way functions (in fact, the construction applies to all monotone functions computable by polynomial-size span programs). This scheme, however, requires trusted setup (whose randomness the recovery procedure does not recover). We give it for completeness, hoping that it will be useful in related contexts in the future.
Theorem 0.3. Assuming that a one-way function exists and trusted setup, there is a (computational) secret sharing scheme with randomness recovery for every monotone function in NC1.

### 1 Technical Overview

Prior work has shown that Single-Key Attribute-Based Encryption (ABE) with Weak Function-Hiding property implies Designated Verifier NIZK argument for NP (In fact they prove equivalence of these two primitives assuming public-key encryption exists.). Recall that an ABE scheme allows us to encrypt a message m under some public parameters pp (generated by a setup procedure along with a master secret key msk) with respect to an attribute a to yield a ciphertext ct. The ciphertext can be decrypted using a secret key sk_{ƒ} associated with a particular function ƒ. The decryption algorithm recovers the message m if and only if ƒ(x)=1. (In this work, we will interpret ƒ as a predicate). The semantic security of an ABE requires that if ƒ(x)=0, then the ciphertext ct must not reveal any information about the message m, even upon given access to the function secret key sk_{ƒ}. It turns out that a weaker version that requires semantic security to hold only in the presence of a single function key suffices to construct DV-NIZK. (In general, an adversary trying to break the semantic security of an ABE scheme is allowed to make oracle queries for arbitrarily many function keys.) In addition, for the construction of DV-NIZK, the ABE needs to satisfy a certain function-hiding property: for all functions ƒ, oracle access to the decryption oracle Dec(sk_{f}, ct) must not reveal any information about ƒ other than whether ƒ(x)=0 or not. (This is weaker than the usual notion of function-hiding for ABE where one requires that the function key sks does not leak information about ƒ.) We consider schemes where the attribute a is publicly known (it can be given out with the ciphertext). This is formally captured by a simulation based definition which informally states that an oracle call to the decryption function should be efficiently simulated using only the master secret key msk and the value of ƒ(x).

In this work, our primary focus is constructing the above ABE scheme for an appropriate function ƒ that will be determined by the NP statement of interest.
Challenges of constructing ABE with function-hiding. While we can construct single-key semantically secure ABE directly from Public Key Encryption, the main challenge arises when we want to achieve any form of function-hiding. The crux of the problem is that an adversary can behave in a way which forces the real world decryption and the simulator to output different messages, which is bad for function-hiding. The function-hiding property seems to be closely related to Chosen Ciphertext Attack (CCA) security in the following sense: In CCA security, one needs to prove security even when an adversary is given access to the decryption oracle. This is similar to the function-hiding setting where the adversary, given access to the decryption oracle, can try to generate malformed ciphertexts to extract information about the underlying function. This similarity has been observed in prior work, and naturally, several tools and techniques which are useful to achieve CCA security have turned out to be useful to construct DV-NIZK as well. In CCA land, one key technique to deal with this issue is to generate two “correlated” ciphertexts, one of which is decrypted using the function secret key and the other is decrypted using an additional secret key which is only a part of master secret key (not included as the function secret key). The key tool that is used to achieve this property is Randomness Recovery. A cryptographic primitive with Randomness recovery is an object where the trapdoor process allows one to (partially) recover the randomness used to generate the hard instance. For example, the notion of PKE with randomness-recovery has been well studied. This is a semantically secure PKE with two additional properties: (1) The decryption process outputs both the message and randomness used during encryption, and (2) there is an efficient and deterministic algorithm that correctly outputs the message upon input the ciphertext and the randomness used for encryption (without having access to the decryption key). Such schemes have been well studied in the context of both CCA security and DV-NIZK, and thus randomness recovery is a natural tool to use in our construction.
ABE with randomness recovery. In prior work, it has been the impression that constructing ABE with weak function-hiding can be achieved by constructing an ABE scheme with some form of randomness recovery. In this work, our goal is to construct an ABE scheme which will satisfy randomness recovery which in turn will naturally yield a single-key semantically secure ABE with weak function hiding. In particular, we are going to construct a standard ABE scheme for a function ƒ with the following additional property: (1) For any attribute a such that ƒ(x)=1, the decryption process can extract both the message and randomness used during encryption, and (2) for any attribute x such that ƒ(x)=1, one can use the master secret key (without access to the function ƒ and secret key) to produce outputs consistent with the real world decryption algorithm.

Construction template. Without loss of generality we will assume a function C that takes as input (ƒ,x) and outputs ƒ(x). We will then construct an ABE for C where the key generation algorithm outputs a public key pk, master secret key msk and secret key sk when queried ƒ. The msk is not revealed to the decryptor and encryptions are generated with respect to attribute a and the particular public key. This abstraction is called Attribute Based Secure Function Evaluation (ABSFE) as established in prior work and is generalization to the usual notion of single-key ABE for the function C(ƒ,.). Moreover in ABSFE the function-hiding analogue is referred to as key-hiding where oracle access to the decryption function does not reveal any information about the “key” ƒ. From here onwards, we will refer to ƒ as the key.

Building blocks for the construction. We will now present the general template of our construction. While this template will not achieve all the properties that we want, we gradually augment this primary construction with additional tools in a step-wise manner, eventually obtaining the final construction.

As building blocks, we will use:
1. A family of pairwise independent hash functions [symbol] .
2. A secret sharing scheme with access function C(·, x):{0, 1}ⁿ→{0, 1} that has a randomized share generating algorithm and a deterministic reconstruction algorithm (The notation C(·, x) means the function C hardcoded with x.). The share generating algorithm that takes as input x secret s and produces shares(a_{1,0}, a_{1,1}, . . . , a_{n,0}, a_{n,1}), and the reconstruction algorithm that takes an input “authorized” sets of shares and outputs the secret and satisfies usual correctness and privacy properties. Specifically, if C(ƒ,x)=1, then {aᵢ,ƒᵢ}_{i∈[n]} should correctly reconstruct the secret s. On the other hand, if C(ƒ,x)=0, then {aᵢ,ƒᵢ}_{i∈[n]} should reveal nothing about the secret s in the information theoretical sense. As mentioned in the introduction, such a scheme has been referred to as a secret sharing scheme for non-monotone functions in the literature.
For the time being, let us assume that an efficient secret sharing scheme of this form exists for C(·, x). We will discuss later in this section when this is possible.
3. An (injective) trapdoor function with setup. Such a function has an additional setup algorithm which on input the security parameter outputs the function g along with a trapdoor g⁻¹. The trapdoor satisfy the natural property that g⁻¹ (g(x))=x.

Informally, our construction follows the blueprint here:
The setup algorithm samples a hash function H from a pairwise-independent hash family as public parameter.
The key generation procedure takes as input the key ƒ. Let ƒ be n bits long. Then it generates a sequence of functions along with its inverse with using the trapdoor function setup. Call them

$${( {g}_{{i}_{i} b} , {g}_{i , b}^{- 1} )}_{i ∈ [ n ] , b ∈ \{ 0 , 1 \}} .$$

The function description g_{i,b} are set as public key pk, and the secret key sk includes the key ƒ along with trapdoor keys [symbol] The master secret key contains all the other trapdoors.
To encrypt a message m under attribute x, first sample a random secret s and use the share generating algorithm to produce (a_{1,0}, a_{1,0}, . . . , a_{n,0}, a_{n,1}). The ciphertexts are set as {ct_{i,b}←g_{i,b}(a_{i,b})}_{i∈[n],b∈{0,1}}. Finally, use H to generate ct₀=m ⊕H(s).
Decryption works by first computing shares corresponding to the indices for which the secret key has the trapdoor, i.e., for all

$${g}_{i , {f}_{i}}^{- 1} ∈ sk , compute {a}_{i , {f}_{i}} = - {g}_{i , {f}_{i}}^{- 1} ( {ct}_{i , {f}_{i}} ) .$$

Then use the secret sharing reconstruction procedure to generate s. Finally output ct₀⊕H(s).

Correctness. Whenever (ƒ,x) is such that C(ƒ,x)=1, correctness is straightforward because (1) the inversion correctness of the trapdoor function ensures that the correct shares {a_{i,f}_{ᵢ}}_{i∈[n]} are computed and (2) C(ƒ,x)=1, therefore {aᵢ,ƒᵢ}_{i∈[n]} are authorized to extract the secret s. Hence, the reconstruction correctness of secret sharing ensures that ct₀⊕H(s)=m.

Message-hiding for ABSFE. To show message-hiding, we have to prove that if the key ƒ is not authorized to reveal the secret, i.e., C(ƒ,x)=0, then encryption of m₀ is indistinguishable from encryption of m₁. The most natural way to proceed with the proof would be to use the randomness extraction property of H and replace ct₀⊕H(s) in the encryption step to a uniform random value. Observe that the view of an adversary includes all the functions:{g_{i,b}}_{i∈[n],b∈{0,1}}, some of the shares:{a_{i,fi}}_{i∈[n]} and trapdoor function evaluations of the other shares:{g_{i,1-ƒ}_{ᵢ}(a_{i,1-ƒ}_{ᵢ})}i∈[n], and m₀⊕H(s). We can appeal to the privacy of the secret sharing scheme and say that {a_{i,ƒ}_{ᵢ}}[n] does not reveal any information about s. However the adversary also sees {g_{i,1-ƒ}_{ᵢ}(a_{i,1-ƒ}_{ᵢ})}i∈[n], and because g_{i,1-ƒ}_{ᵢ} is injective, the conditional entropy of s given {g_{i,1-ƒ}_{ᵢ}(a_{i,1-ƒ}_{ᵢ})}_{i∈[n]} is 0 as s can be reconstructed efficiently given all the shares. So, there is absolutely no entropy left to use the randomness extractor H and we cannot hope to use any sort of Leftover Hash Lemma for randomness extraction.

Key Ingredient 1: Lossy Trapdoor Function. Trapdoor functions do not seem sufficient to achieve message hiding. To solve this issue, we will replace them with Lossy Trapdoor Functions (LTDF). The notion of Lossy trapdoor function was introduced in prior work which is a public function ƒ that behaves in one of two modes.
The first mode gives a (injective) trapdoor function: given a suitable trapdoor for g, i.e., g⁻¹, the input x can be efficiently recovered from g(x). In this mode, the setup outputs the trapdoor along with the function description.
In the second mode g statistically loses a significant amount of information about its input, i.e., g's image is significantly smaller than its domain.
   The two behaviors are computationally indistinguishable: given just the description of g, no efficient adversary can tell whether g is injective or lossy.

Once we make this change, i.e.,

$$( {g}_{i , b} , {g}_{i , b}^{- 1} )$$

are now generated by the setup for lossy trap-door function, we can indeed make the message hiding proof go through without affecting correctness. In more detail, we will generate the functions in the injective mode in the construction, and therefore correctness remains unaltered. However, to prove message hiding, we will first switch the lossy trapdoor function setup such that {g_{i,1-ƒ}_{ᵢ}}_{i∈[n]} are generated in the lossy mode. Now, the view of the adversary again contains {g_{i,1-ƒ}_{ᵢ}(a_{i,1-ƒ}_{ᵢ})}_{i∈[n]} but now the lossiness ensure that the residual entropy of s given these evaluation is high enough for the randomness extractor to work. Indeed, we have to pick the parameters carefully to make sure that there is enough information ambiguity in the lossy evaluation to apply the Leftover Hash Lemma. In particular, we need to use a slightly stronger version of lossy trapdoor functions called length-parameterized lossy trapdoor functions. Length-parameterized lossy (trapdoor) functions, as introduced in prior work, are similar to lossy (trapdoor) functions with a stronger requirement that the setup algorithm takes as input ∠ₗᵢₙ explicit input length parameter [symbol] ᵢₙ and the range of the function in the lossy mode is independent of [symbol] ᵢₙ. The original constructions of lossy trapdoor function from DDH and the recent constructions from LWE satisfy this property.

Remark 1,1. Since we know the indices i for which ƒᵢ=0, we can set the lossy trapdoor function keys in the constructions in way that does not require us to switch from injective to lossy mode for the keys {g_{i,1-ƒ}_{ᵢ}}_{i∈[n]} in the proof. Specifically, we sample {g_{i,1-ƒ}_{ᵢ}}_{i∈[n]} in the lossy mode and {g_{i,f}_{ᵢ}}i∈[n] in the injective mode, thereby avoiding the need to rely on the computational setup indistinguishability property of the lossy trapdoor function. In this way, we get the property that message-hiding is statistical (assuming the secret sharing is information theoretically secure).

Key-hiding for ABSFE. Unfortunately, the template above, as is, does not satisfy key-hiding. It turns out that an adversary with access to a decryption oracle can send malformed ciphertexts as queries that will leak non-trivial information about the key ƒ. Concretely, consider the following scenario: there is an adversary who is aware of some kay and attribute pair (ƒ*, x) such that C(ƒ*, x)=1 and they also know that the description of ƒ* is 0 everywhere other than its most significant bit.

Therefore, if the key generation algorithm for the ABSFE generated keys corresponding to ƒ* and if the encryption is done honestly as prescribed above, then the shares(a_{1,1}, a_{2,0}, . . . , a_{n,1}) should be sufficient to recover the secret s and therefore the encrypted message.

However, the adversary chooses to not generate the encryptions honestly but rather does the following tampering: To encrypt a message m under attribute x, the adversary first samples a random secret s and use the share generating algorithm to honestly produce (a_{1,0}, . . . , a_{n,1}). At this point, the adversary deviates from the encryption procedure. Instead of setting {ct_{i,b}←g_{i,b}(a_{i,b})}_{i∈[n],b∈{0,1}}, it first picks arbitrary values

$${\{ {a}_{i , 1 - {f}_{i}^{*}}^{′} \neq {a}_{i , 1} - {f}_{i}^{*} \}}_{i ∈ n} .$$

Then it sets

$$c {t}_{i , 1 - {f}_{i}^{*}} = {g}_{i , 1 - {f}_{i}^{*}} ( {a}_{i , 1 - {f}_{i}^{*}}^{′} )$$

for all i∈[n] and

$$c {t}_{i , {f}_{i}^{*}} = {g}_{i , {f}_{i}^{*}} ( {a}_{i , {f}_{i}^{*}} )$$

all i∈[n]. Finally, it use H to generate ct₀=m ⊕H(s).

Such an adversary can learn non-trivial information about the key using the response of the decryption orace and break the key-hiding property. Consider the two cases:
If the key generation produced secret keys corresponding to ƒ*, then the secret key has

$${\{ {g}_{i , {f}_{i}^{*}}^{- 1} \}}_{i ∈ [ n ]} ,$$

and it can therefore extract (a_{1,1}, a_{2,0}, . . . , a_{n,1}). Since the description of ƒ* has a 1 in its most significant bit only, the decryption oracle can reconstruct some secret s′ just by using (a_{1,1}, a_{2,0}, . . . , a_{n,1}). And because the adversary did not modify the honestly generated (a_{1,1}, a_{2,0}, . . . , a_{n,1}), the reconstruction must always produce the correct secret s′=s. Thus the decryption oracle responds with ct₀ e H(s′)=ct₀⊕H(s)=m.
On the other hand, if the key generation produced secret keys corresponding to some ƒ≠ƒ* such that C(ƒ,x)=1, then there is no guarantee that the s′ reconstructed will match the same secret s used in the encryption. The reconstruction algorithm receives shares which are not generated by an honest share generating process and therefore provides no guarantee of reconstruction correctness. In fact in the worst case where the description of ƒ has 0 in the most significant position and 1 everywhere else, then the reconstruction process is run only on tampered shares which are completely independent of the secret s. Therefore it is very likely that ct₀⊕H(s′)≠ct₀⊕H(s)≠m.

To conclude, depending on if the decryption oracle returns the correct message m or otherwise, then the adversary can be fairly confident whether the key ƒ* was used or not.

In order to prevent such malicious behavior, there has to be some way to perform a consistency checks while decrypting to ensure that the adversary cannot take advantage of malformed ciphertexts.

Key Ingredient 2: Secret Sharing with Randomness Recovery. Our problem with proving key-hiding is resolved if we have a secret sharing scheme with an additional randomness recovery property, i.e., the reconstruction algorithm upon input C(·, x) and {aᵢ}_{i:f}_{ᵢ}=1 correctly outputs all other shares, i.e., {aᵢ}_{i:f}_{ᵢ}₌₀ along with s. Given such a primitive, we can modify our decryption as follows:
First compute shares corresponding to the indices for which the secret key has the trapdoor, i.e., for all

$${g}_{i , {f}_{i}}^{- 1} ∈ sk , compute {a}_{i , {f}_{i}} = {g}_{i , {f}_{i}}^{- 1} ( {ct}_{i , {f}_{i}} ) .$$

Then use the secret sharing reconstruction to generate s, (a_{1,0}, a_{1,1} . . . , a_{n,0}, a_{n,1}). To test for malformed ciphertexts, we run a consistency check. Specifically, check if g_{i,b}(a_{i,b})=ct_{i,b} for all i∈[n], b∈{0, 1}. If yes, then output ct₀⊕H(s). Otherwise output ⊥.

Now, if our secret sharing has the additional property that the regenerated shares are indeed correctly distributed, the attack described above no longer works. In particular, if an adversary tries to use malformed ciphertexts, then the consistency checks in the decryption algorithm should fail and it will output ⊥. Thus, such a secret sharing scheme suffices to achieve key-hiding for the ABSFE. We refer readers to Section 4 for formal details.

Constructing the secret sharing scheme As mentioned above, a secret sharing scheme for non-monotone function F:{0, 1}ⁿ→{0, 1} splits a secret into 2n shares and satisfies the usual correctness and privacy properties, namely, (1) the collection of shares {sᵢ: xᵢ=1}∪{tᵢ:xᵢ=0} determines the secret if F(x₁, . . . , xₙ)=1, and (2) if F(x₁, . . . , xₙ)=0, then {sᵢ:xᵢ=1}∪{tᵢ:xᵢ=0} does not reveal anything about the secret (information theoretically). In addition to these, a secret sharing with randomness recovery has a deterministic regeneration procedure that can generate all 2n shares given {sᵢ:xᵢ=1}∪{tᵢ:xᵢ=0} along with the secret s if F(x₁, . . . , xₙ)=1.

In this work, we construct an information theoretically private secret sharing scheme for any non-monotone functions F that can computed by a polynomially sized branching program. Such functions are said to belong to the complexity class PBP and can be represented using a Directed Acyclic Graph (DAG) with n+2 nodes (The number of nodes in the graph will not be n+2 in general. Rather it will be some polynomial in n. However for the sake of simplicity let us assume it is n+2 for now as it does not affect the construction in a significant manner. The technical sections have accurate parameters.) (ν₁, . . . , vₙ₊₂) where v₁ is assigned as the source node, and vₙ₊₁ and vₙ₊₂ are assigned as accept and reject sink nodes respectively. All non sink nodes labelled {v₁, . . . , vₙ} have exactly two outgoing edges labelled (i, b), for i∈[n] and b∈{0, 1}. The DAG has the property that the set of edges marked as {(i, x;)} has a path from v₁ to the accept node if and only if F(x)=1 for some input x. At a high level, the secret sharing scheme works as follows:
Share Generation. Given a secret s, assign it to vₙ₊₁. Assign 0 to v₁ and vₙ₊₂. For all other nodes, assign random values rᵢ. Let valᵢ be the value assigned to node vᵢ. Every edge is now assigned a share a_{i,b}=valⱼ−valᵢ if (i, b) is an edge between nodes vᵢ and vⱼ. These are the final shares, i.e., {a_{i,b}}_{i∈[n],b∈{0,1}}.
Secret Reconstruction. If one is given access to shares {a_{i,x}_{ᵢ}} and F(x)=1, then we know by property of the DAG that the edges corresponding to these shares contain among them a directed path from v₁ to vₙ₊₁ and such a path can be efficiently found. To reconstruct the secret simply add the shares along this path. Correctness is easy to see by observing that summing shares along a path has a telescopic affect that cancels all intermediate values and results in valₙ₊₁−val₁ that equals the secret s.
Share Regeneration. Observe that every set of shares {a_{i,x}_{ᵢ}}_{i∈[n]} contains share corresponding to exactly one of out two outgoing edges from every non-sink node. Therefore, the set {a_{i,x}_{ᵢ}}_{i∈[n]} contains shares along a path from every node vᵢ to either vₙ₊₁ Or vₙ₊₂. If F(x)=1, then using the above bullet point, one can recover the secret s, and thus get access to valₙ₊₁. It is known that val₁=0 and valₙ₊₁=0. Now to compute valᵢ, one can simply add shares along the path from vᵢ to vₙ₊₁ or vₙ₊₂. Once all {valᵢ}_{i∈[n+2]} are recovered, it is straightforward to compute the shares {a_{i,b}}_{i∈[n],b∈{0,1}}.

Additional technical details. We have hidden some details under the rug in this description. In the above description, we have argued shared regeneration correctness only when the shares the honestly generated using the share generation algorithm. However, an adversary trying to break key-hiding need not generate shares using this procedure. Therefore, for the key-hiding proof to work we have to ensure that there is some way for the share regeneration procedure to detect “invalid” shares. This is captured by the “Regeneration Soundness” property in our formalization.

We refer readers to Section 3 for more details.

In our application of DV-NIZK, the function C is essentially a PRF and (ƒ,x) are the PRF key and evaluation point respectively. Therefore we need to construct the secret sharing with randomness recovery scheme for the access function PRF(., x). Since we build such a secret sharing scheme for a functions restricted to the complexity class PBP, we also need to additionally assume the existence of PRF in PBP.

We refer readers to Section 4 and Section 5 for more details.

### 2 Preliminaries

Notations. We use eᵢ to denote a vector with 1 at the i^{th} index and 0 everywhere else. For a matrix M, M_{i,j} denotes the entry at the (i, j) position. M_{i,}. and M_{.,i} denote the i^{th} row and column respectively.

The statistical distance between two random variables X and Y having the same (countable) domain [symbol] is

$$Δ ( X , Y ) = \frac{1}{2} {\sum }_{υ ∈ 𝒟} \vert Pr [ X = υ ] - Pr [ Y = υ ] \vert .$$

We say that two variables are e-close if their statistical distance is at most ∈. We use the notation D₁≈ₑD₂ to denote that the statistical distance between two distributions D₁ and D₂ is∈.

Negligible Function: A function ƒ: [symbol] →(0, 1) is said to be negligible if for every positive constant c, there exists n₀∈ [symbol] such that for all n>n₀, ƒ(n)≤n^{-c}.

Two distributions D₁ and D₂ (indexed by security parameter λ) are said to be computationally indistinguishable if for all PPT adversaries [symbol] , there exists a negligible function neg| such that

$$\vert {Pr}_{x ← {D}_{1}} [ ( x ) = 1 ] - {Pr}_{x ← {D}_{2}} [ ( x ) = 1 ] \vert \leq negl ( λ ) .$$

Analogously, two distributions D₁ and D₂ are statistically indistinguishable if for all (not restricted to PPT) adversaries [symbol] , there exists a negligible function neg| such that

$$\vert {Pr}_{x ← {D}_{1}} [ ( x ) = 1 ] - {Pr}_{x ← {D}_{2}} [ ( x ) = 1 ] \vert \leq negl ( λ ) .$$

Definition 2.1. A family [symbol] {H:D→R}is said to be pairwise independent, if for any two distinct elements x₁≠x₂∈D, and any two y₁, y₂∈R,

$${Pr}_{H ∈ ℋ} [ H ( {x}_{1} ) = {y}_{1} and H ( {x}_{2} ) = {y}_{2} ] = \frac{1}{{\vert R \vert}^{2}} .$$

### 2.1 Randomness Extraction

The min-entropy of a random variable X is

$${H}_{∞} ( X ) = - log ( {max}_{x} Pr [ X = x ] ) .$$

In several settings, the variable X is correlated with another variable Y whose value is known to the adversary. The notion of conditional minimum entropy quantifies the amount of information needed to describe the outcome of X given the outcome of another random variable Y. Formally, it is defined as H_{∞}(X|Y=y)=−log (maxₓPr[X=x |Y=y]). In this work, we use a notion called average conditional min-entropy as established in prior work, which captures the remaining unpredictability of X conditioned on the value of Y:

$${\tilde{H}}_{∞} ( X \vert Y ) := - log ( {𝔼}_{y ← Y} [ {2}^{- {H}_{∞} ( X \vert Y = y )} ] ) .$$

The average min-entropy corresponds exactly to the optimal probability of guessing X, given knowledge of Y. The following bound on average min-entropy has been previously established:

Lemma 2.2. If Y has 2^{r} possible values and Z is any random variable, then \tilde{H}_{∞}(X|(Y, Z))≥H_{∞}(X|Z)−r.

The following lemma is also known from prior work.

Lemma 2.3. Let X, Y be random variables such that X∈{0, 1}ⁿ and \tilde{H}_{∞}(X|Y)≥k. Let [symbol] be a family of pairwise independent hash functions from {0, 1}ⁿ to [symbol] . Then for h← [symbol] , we have

$$Δ ( ( Y , h , h ( X ) ) , ( Y , h , {U}_{ℓ} ) ) \leq ϵ$$

as long as [symbol] <k−2lg(1/∈).

### 2.2 Length-Parameterized Lossy Trapdoor Functions

The notion of Lossy trapdoor function was introduced in prior work which is a public function ƒ that behaves in one of two modes. The first mode gives a (injective) trapdoor function: given a suitable trapdoor for ƒ, the input x can be efficiently recovered from ƒ(x). In the second mode, ƒ statistically loses a significant amount of information about its input, i.e., ƒ's image is significantly smaller than its domain. Finally, the two behaviors are indistinguishable: given just the description of ƒ, no efficient adversary can tell whether ƒ is injective or lossy.

Length-parameterized lossy (trapdoor) functions, introduced in prior work, are similar to lossy (trapdoor) functions with a stronger requirement that the setup algorithm takes as input [symbol] ₗᵢₙ explicit input length parameter [symbol] ᵢₙ. As in previous work, there is both an injective and a lossy mode of setup and these should be computationally indistinguishable. However, the image size of the function in the lossy mode should be a polynomial that depends only on the security parameter and is independent of [symbol] ᵢₙ. The trapdoor allows to invert arbitrary outputs (when instantiated in the injective mode).

More precisely, a length-parameterized lossy trapdoor function is a tuple of efficient algorithms LTDF=(LTDF.Setup, LTDF.AltSetup, LTDF.Eval, LTDF.Invert) with the following sytax.
(ev,td)←LTDF.Setup(1,^{λ} [symbol] ): On input the security parameter λ and an input length [symbol] ᵢₙ (both in unary), the setup procedure outputs an evaluation key ev and a trapdoor key td. We assume that ev contains an implicit description of [symbol] ᵢₙ.
ev←LTDF.AltSetup (1^{λ}, [symbol] ): On input the security parameter λ, and an input length [symbol] ᵢₙ (both in unary), the alternate-setup procedure outputs an evaluation key ev. We assume that the key ev contains an implicit description of [symbol] ᵢₙ.
y←LTDF.Eval(ev,x): On input a key ev and an input x∈ [symbol] , the evaluation procedure outputs a value y∈ [symbol] , for some output length [symbol] ₒᵤₜ that is determined during function setup.
y←LTDF.Invert(td, y): On input x trapdoor key td and an input y∈ [symbol] , the inversion procedure outputs a value x∈ [symbol] .

Below, we formalize the properties that an LTDF as above should satisfy.
Efficiency: For all security parameter λ∈ [symbol] ,
   [symbol] ᵢₙ=poly(λ) and [symbol] ₒᵤₜ=poly(λ).
   LTDF.Setup, LTDF.AltSetup, and LTDF.Eval are probabilistic algorithms that run in time poly(λ, [symbol] _{∈}). LTDF.Invert is a probabilistic algorithm that runs in time poly(λ, [symbol] ₒᵤₜ).
Correctness of trapdoor inversion: For all λ∈ [symbol] , lᵢₙ=poly(λ), every input x∈ [symbol] ,

$$Pr \{ LTDF . Invert ( td , LTDF . Eval ( e υ , x ) ) = x ] = 1 ,$$

where the probability is over the choice of (ev,td)←LTDF.Setup(1^{λ}, [symbol] ). Note that this property implies injectivity.
Lossiness in alternate mode: There exists a polynomial p(·) such that for all λ, [symbol] ᵢₙ ∈poly(λ) the following holds. Let ev←LTDF.AltSetup (1^{λ}, [symbol] ) and

$${𝒮}_{e υ} = \{ y ∈ {\{ 0 , 1 \}}^{{ℓ}_{o u t}} \vert ∃ x : LTDF . Eval ( e υ , x ) = y \}$$

It must be that

$$\vert {𝒮}_{e υ} \vert \leq {2}^{p ( λ )} , p ( λ ) \leq {ℓ}_{i n} .$$

In other words, the image size is bounded by a polynomial in > which is independent of [symbol] ᵢₙ.
Mode indistinguishability: For all λ, [symbol] ᵢₙ=poly(λ) and PPT adversaries [symbol] , there exists a negligible function neg|(·) such that,

$$\vert Pr [ ( e υ ) = 1 \vert ( e υ , td ) ← LTDF . Setup ( {1}^{λ} , {1}^{{ℓ}_{i n}} ) ] - Pr [ ( e υ ) = 1 \vert e υ ← LTDF . AltSetup ( {1}^{λ} , {1}^{{ℓ}_{i n}} ) ] \vert \leq negl ( λ )$$

Theorem 2.4 (Established in prior work). Let λbe the security parameter. Assuming (m, q, σ)-LWE is hard for σ=ω(λ), and for all polynomials m, q, there exists an LTDF= (LTDF.Setup, LTDF.AltSetup, LTDF.Eval, LTDF.Invert).
Theorem 2.5 (Established in prior work). Assuming hardness of DDH, there exists an LTDF=(LTDF.Setup, LTDF.AltSetup, LTDF.Eval, LTDF.Invert).

### 2.3 Zero-Knowledge Probabilistic Checkable Proof (ZK-PCP)

As introduced in prior work, a ZK-PCP is like a PCP with the additional property that the view of the verifier can be efficiently simulated without access to the witness up to a small statistical distance.

Definition 2.6 (Definition adapted from prior work). Let [symbol] :{0, 1}ⁿ×{0, 1}^{h}→{0, 1} be an NP relation and [symbol] ∈{0, 1}ⁿ be the associated language. A non-adaptive, [symbol] -query zero-knowledge PCP with alphabet Σ for [symbol] is a tuple of algorithms:
π<zkPCP.Prove(x, w): On input x statement x∈{0, 1}ⁿ and a witness {0, 1}^{h}, the prove algorithm outputs a proof π∈Σ^{m}.
(stₓ, q₁, . . . , q [symbol] )←zkPCP.Query(x): On input the statement x, it outputs a verification state stₓ and [symbol] query indices q₁, . . . , q [symbol] ∈[m].
{0, 1}←zkPCP.Ver(stₓ, s₁, . . . , [symbol] ): On input the verification state st and a set of responses s₁, . . . , [symbol] ∈Σ, output a bit.

A zkPCP satisfies the following properties:
Efficiency: The running time of zkPCP. Prove, zkPCP.Query and zkPCP. Ver should be bounded by poly(n). In particular m∈poly(n).
Completeness: For all x∈{0, 1}ⁿ and w∈{0, 1}^{h}, if [symbol] (x, w)=1, then,

$$Pr [ zkPCP . Ver ( s {t}_{x} , {π}_{{q}_{1}} , … , {π}_{{q}_{ℓ}} ) = 1 ] = 1 ,$$

where π←zkPCP.Prove(x, w) and (stₓ, q₁, . . . , q [symbol] )←zkPCP.Query(x).
Soundness: There exists a negligible function neg|(·) such that for all n, m∈ [symbol] , x∉ [symbol] and |x|=n, all proof strings π∈Σ^{m},

$$Pr [ zkPCP . Ver ( {st}_{x} , {π}_{{q}_{1}} , … , {π}_{{q}_{ℓ}} ) = 1 ] = negl ( n ) , where )$$

$$( {st}_{x} , {q}_{1} , … , {q}_{ℓ} ) ← zkPCP . Query ( x )$$

Semi-malicious Computational Zero-Knowledge: For all PPT adversaries [symbol] =( [symbol] ₁, [symbol] ₂), there exists an efficient simulator Sim and a negligible function neg|(·) such that,

$$\vert Pr [ {𝒜}_{2} ( {st}_{A} , {π}_{{q}_{1}} , … , {π}_{{q}_{ℓ}} ) = 1 \vert ℛ ( x , w ) = 1 ] - Pr [ {𝒜}_{2} ( {st}_{𝒜} , {\tilde{π}}_{{q}_{1}} , … , {\tilde{π}}_{{q}_{ℓ}} ) = 1 \vert ℛ ( x , w ) = 1 ] \vert \leq negl ( λ ) ,$$

$$where ( {st}_{𝒜} , x , w , r ) ← {𝒜}_{1} ( {1}^{n} ) , ( {q}_{1} , … , {q}_{ℓ} ) ← zkPCP . Query ( x ; r ) ,$$

$$π ← zkPCP . Prove ( x , w ) , ( {\tilde{π}}_{{q}_{1}} , … , {\tilde{π}}_{{q}_{ℓ}} ) ← Sim ( x , {q}_{1} , … , {q}_{ℓ} ) .$$

Semi-malicious Statistical Zero-Knowledge: For all adversaries [symbol] =( [symbol] ₁, [symbol] ₂), there exists an efficient simulator Sim and a negligible function neg|(·) such that,

$$\vert Pr [ {𝒜}_{2} ( {st}_{A} , {π}_{{q}_{1}} , … , {π}_{{q}_{ℓ}} ) = 1 \vert ℛ ( x , w ) = 1 ] - Pr [ {𝒜}_{2} ( {st}_{𝒜} , {\tilde{π}}_{{q}_{1}} , … , {\tilde{π}}_{{q}_{ℓ}} ) = 1 \vert ℛ ( x , w ) = 1 ] \vert \leq negl ( λ ) ,$$

$$where ( {st}_{𝒜} , x , w , r ) ← {𝒜}_{1} ( {1}^{n} ) , ( {q}_{1} , … , {q}_{ℓ} ) ← zkPCP . Query ( x ; r ) ,$$

$$π ← zkPCP . Prove ( x , w ) , ( {\tilde{π}}_{{q}_{1}} , … , {\tilde{π}}_{{q}_{ℓ}} ) ← Sim ( x , {q}_{1} , … , {q}_{ℓ} ) .$$

Remark 2.7 (Malicious ZK). A stronger notion of malicious zero-knowledge where (q₁, . . . , q [symbol] ) are maliciously generated can also be defined. We refer readers to prior work for the formal definition. For our application to DV-NIZK, the weaker semi-malicious zero-knowledge suffices.

Instantiating ZK-PCP with statistical zero knowledge As noted in prior work, the non-interactive zero knowledge construction from previous work relies on a semi-malicious zero-knowledge PCP. To elaborate, in order to prove that a graph is 3-colorable, the prover assigns a color to each node. This coloring serves as the PCP string which the verifier can query. The (semi-malicious) verifier can now query a random edge (pair of nodes) from this string, and checks if the corresponding colors are distinct. This construction involves no computational assumptions, and indeed satisfies statistical zero-knowledge against semi-malicious verifiers. While the base construction only achieves 1-1/poly(n) soundness, this can be amplified by parallel repetition, i.e., generating multiple independent copies of the PCP. Note that semi-malicious zero-knowledge is preserved by parallel repetition.
Theorem 2.8 (Semi-malicious zkPCP from prior work). There exists an [symbol] -query PCP with statistical soundness and semi-malicious statistical zero-knowledge for all NP, alphabet Σ={0, 1,2}, and [symbol] =poly(n).

Additional instantiations of zkPCP exist; see, for example, prior work.

### 2.4 Weak Function-Hiding Single-Key Attribute-Based Encryption

We define an Attribute-Based encryption (ABE) scheme with a certain function-hiding property. In this work, it suffices to construct an ABE scheme that satisfies semantic security with a single function key. Such ABE schemes (without the function hiding property) have been well studied and are known to exist assuming Public Key Encryption.

Definition 2.9 (Adapted from prior work). An Attribute-Based Encryption (ABE) scheme over a message space [symbol] , attribute space [symbol] , and function family [symbol] ={ƒ: [symbol] →{0, 1}}is a tuple ABE=(ABE.Setup, ABE.Keygen, ABE.Enc, ABE.Dec) such that:
(pp, msk)←ABE.Setup(1²): The setup algorithm on input the security parameter>outputs the public parameters pp and master secret key msk.
sk←ABE.Keygen (pp, msk, ƒ): The generation algorithm on input the public parameters, master secret key, function ƒ∈ [symbol] , outputs a function secret key sk.
ct←ABE.Enc(pp,x,m): The encryption algorithm takes as input the public parameters, attribute x and message m & M, and outputs a ciphertext ct.
(x,m)←ABE.Dec(pp,sk,ct): The decryption algorithm takes as input the public parameters, secret key sk (which maybe the master secret key) and ciphertert ct, and outputs an attribute x∈ [symbol] and message m∈ [symbol] ∪≐.

A Weak Function-Hiding ABE scheme with the above algorithms satisfies the following properties:
(Perfect) Correctness: For all messages m∈ [symbol] , attributes x∈ [symbol] , predicates ƒ∈ [symbol] ,

$$Pr [ ABE . Dec ( pp , msk , ABE . Enc ( pp , x , m ) ) = m \vert ( pp , msk ) ← ABE . Setup ( {1}^{λ} ) ] = 1.$$

$$If f ( x ) = 1 , then$$

$$Pr [ ABE . Dec ( pp , ABE . Keygen ( pp , msk , f ) , ABE . Enc ( pp , x , m ) ) = m \vert ( pp , msk ) ← ABE . Setup ( {1}^{λ} ) ] = 1.$$

Single-Key Semantic Security: For all λ∈ [symbol] , and all admissible PPT adversaries ( [symbol] ₁, [symbol] ₂), there exists a negligible function neg|(·) such that

$$Pr [ {b}^{′} ← {𝒜}_{2}^{𝒪 ( pp , b , \cdot , \cdot , \cdot )} ( pp , sk , τ ) ∧ {b}^{′} = b \vert ( f , τ ) ← {𝒜}_{1} ( {1}^{λ} ) , \text{} ( pp , msk ) ← ABE . Setup ( {1}^{λ} ) , sk ← ABE . Keygen ( pp , msk , f ) , b {←}^{\$} \{ 0 , 1 \} ] = negl ( λ ) ,$$

$$where$$

[symbol] ((pp, b, x,m₀, m₁) is an oracle which upon queried an attribute x, messages m₀,m₁ ∈ [symbol] returns a ciphertext ct←ABE.Enc(pp,x,mb).
   [symbol] is admissible if it makes one ciphertext query (a, m₀, m₁) to [symbol] , and ƒ(x)=0.
Weak Function-Hiding: (This is weaker than the standard notion of function-hiding ABE. Informally, a function-hiding ABE requires that the function secret key hides the function. On the other hand, here, we want that oracle access to the decryption function does not leak information about the function) For all λ∈ [symbol] , and p=poly(λ), there exists a PPT simulator Sim such that for all functions ƒ∈ [symbol] , and for all PPT adversaries [symbol] , there exists a negligible function neg|(·) such that

$$\vert Pr [ {𝒜}^{{𝒪}_{1} ( pp , sk , \cdot )} ( pp ) \vert ( pp , msk ) ← ABE . Setup ( {1}^{λ} ) , \text{} sk ← ABE . Keygen ( pp , msk , f ) ] - Pr [ {𝒜}^{{𝒪}_{2} ( pp , msk , \cdot )} ( pp ) \vert ( pp , msk ) ← ABE . Setup ( {1}^{λ} ) ] \vert \leq negl ( λ ) .$$

Here,
   [symbol] ₁(pp,sk,ct) is the real decryption oracle which upon queried a ciphertext ct∈{0, 1}^{p}, outputs ABE.Dec(pp,sk,ct).
   [symbol] ₂(pp, msk,ct) is the ideal decryption oracle which upon queried a ciphertext ct∈{0, 1}^{p}, outputs Sim^{ƒ(·)}(pp, msk,ct). Moreover, Sim is restricted to query ƒ(·) at most once per invocation.

### 2.5 Attribute-Based Secure Function Evaluation (ABSFE)

An ABSFE is a generalization of single-key ABE satisfying the following two notions of security: (1) Weak message hiding (analogous to single-key semantic security of ABE), and (2) Strong key hiding (analogous to weak function-hiding property of ABE).

Definition 2.10 (Adapted from prior work). An Attribute-Based Secure Function Evaluation (ABSFE) scheme for a function F:X× [symbol] →{0, 1} with message space [symbol] is a tuple ABSFE=(ABSFE.Setup, ABSFE.Keygen, ABSFE.Enc, ABSFE.Dec) such that:
pp←ABSFE.Setup(1^{λ}): The setup algorithm on input the security parameter λoutputs the public parameters pp.
(pk, sk)←ABSFE.Keygen (pp, y): The generation algorithm on input the public parameters, and a value y∈ [symbol] , outputs a public key pk and secret key sk.
ct←ABSFE.Enc(pp, pk, x,m): The encryption algorithm takes as input the public parameters, public key, a value x∈ [symbol] , and message m∈ [symbol] , and outputs a ciphertext ct.
m←ABSFE.Dec(pp,sk, x, ct): The decryption algorithm takes as input the public parameters, secret key sk, an attribute x and ciphertert ct, and outputs a message m∈ [symbol] ∪⊥.

An ABSFE scheme with the above algorithms satisfies the following properties:
(Perfect) Correctness: For all messages m∈ [symbol] , x∈ [symbol] , y∈ [symbol] , where F(x,y)=1,

$$Pr [ ABSFE . Dec ( pp , sk , x , ABSFE . Enc ( pp , pk , x , m ) ) = m \vert pp ← ABSFE . Setup ( {1}^{λ} ) , ( pk , sk ) ← ABSFE . Keygen ( pp , y ) ] = 1$$

Weak Computational Message Hiding: This is essentially single-key semantic security for ABE: namely, a ciphertext with attribute x∈ [symbol] encrypted under a public key for y∈ [symbol] where F(x,y)=0 should hide the underlying message.

Definition 2.11. Let ABSFE be an ABSFE scheme for F. Then, for all λ∈ [symbol] , and all admissible PPT adversaries ( [symbol] ₁, [symbol] ₂), there exists a negligible function neg|(·) such that

$$Pr [ {b}^{′} ← {𝒜}_{2}^{𝒪 ( pp , pk , b , \cdot , \cdot , \cdot )} ( pp , pk , sk , τ ) ∧ {b}^{′} = b \vert ( y , τ ) ← {𝒜}_{1} ( {1}^{λ} ) , \text{} pp ← ABSFE . Setup ( {1}^{λ} ) , ( pk , sk ) ← ABSFE . Keygen ( pp , y ) , b {←}^{\$} \{ 0 , 1 \} ] = negl ( λ ) ,$$

where
[symbol] (pp, pk, b, x,m₀, m₁) is an oracle which upon queried an attribute x∈ [symbol] , messages m₀, m₁ ∈ [symbol] returns a ciphertert ct←ABSFE.Enc(pp, pk, x,mb).
[symbol] is admissible if it makes one ciphertert query(x,m₀, m₁) to [symbol] , and F(x,y)=0.
Weak Statistical Message Hiding: We introduce the statistical version of weak message hiding which is essentially single-key statistical semantic security for ABE: namely, a ciphertext with attribute x∈ [symbol] encrypted under a public key for y∈ [symbol] where F(x,y)=0 should statistically hide the underlying message.

Definition 2.12. Let ABSFE be an ABSFE scheme for F. Then, for all λ∈ [symbol] , and all admissible adversaries ( [symbol] ₁, [symbol] ₂), there exists a negligible function neg|(·) such that

$$Pr [ {b}^{′} ← {𝒜}_{2}^{𝒪 ( pp , pk , b , \cdot , \cdot , \cdot )} ( pp , pk , sk , τ ) ∧ {b}^{′} = b \vert ( y , τ ) ← {𝒜}_{1} ( {1}^{λ} ) , \text{} pp ← ABSFE . Setup ( {1}^{λ} ) , ( pk , sk ) ← ABSFE . Keygen ( pp , y ) , b {←}^{\$} \{ 0 , 1 \} ] = negl ( λ ) ,$$

where
[symbol] (pp, pk, b, x,m₀, m₁) is an oracle which upon queried an attribute x∈ [symbol] , messages m₀, m₁∈ [symbol] returns a ciphertext ct←ABSFE.Enc(pp, pk, x,mb).
[symbol] is admissible if it makes one ciphertext query(x,m₀, m₁) to [symbol] , and F(x,y)=0.
Strong Key Hiding: The strong key hiding notion requires that y remains hidden even if the adversary has access to a decryption oracle (with the associated secret key sk). Strong key-hiding is reminiscent of the weak function-hiding property we defined for ABE. It is known that ABE schemes which satisfy weak function-hiding imply ABSFE schemes that satisfy strong key-hiding.

Definition 2.13. For all λ∈ [symbol] , and p=poly(λ), there exists a PPT simulator Sim: =(Sim₁, Sim₂) such that for all keys y∈ [symbol] , and for all PPT adversaries [symbol] , there exists a negligible function neg|(·) such that

$$\vert Pr [ {𝒜}^{{𝒪}_{1} ( pp , sk , \cdot , \cdot )} ( pp , pk ) = 1 \vert pp ← ABSFE . Setup ( {1}^{λ} ) , \text{} ( pk , sk ) ← ABSFE . Keygen ( pp , y ) ] - Pr [ {𝒜}^{{𝒪}_{2} ( st , \cdot , \cdot )} ( pp , pk ) = 1 \vert ( st , pp , pk ) ← {Sim}_{1} ( {1}^{λ} ) ] \vert \leq negl ( λ ) .$$

Here,
[symbol] ₁(pp,sk, x, ct) is the real decryption oracle which upon queried an attribute x∈ [symbol] and a ciphertext ct∈{0, 1}^{p}, outputs ABSFE.Dec(pp,sk, x, ct).
[symbol] ₂ (st, x, ct) is the ideal decryption oracle which upon queried an attribute x and a ciphertext ct∈{0, 1}^{p}, outputs

$${Sim}_{2}^{F ( \cdot , y )} ( st , x , ct ) .$$

Moreover, Sim₂ is restricted to query F(·, y) at most once per invocation.

Remark 2.14. By a standard hybrid argument, any ABSFE scheme that satisfies weak message hiding against an adversary that makes a single challenge query(x,m₀, m₁) is also secure against an adversary that makes polynomially many challenge queries.

Remark 2.15. One can also define a “strong” notion of message-hiding which says semantic security holds even in the setting where the public-key is maliciously chosen. Informally, in this case, we require that there exists an efficient algorithm that can extract an attribute y from any (possibly malformed) public key pk, and ciphertexts encrypted to any attribute a where F(x,y)=0 still hide the underlying message. The weaker notion suffices for our application, thus we refer readers to prior work for a detailed definition.

### 2.6 Reusable Designated Verifier Non Interactive Zero Knowledge

Let L be an NP language associated with an NP relation [symbol] . A reusable designated-verifier non-interactive zero-knowledge (DV-NIZK) argument for L consists of a tuple of three efficient algorithms DV-NIZK=(DV-NIZK.Setup, DV-NIZK.Keygen, DV-NIZK.Prove, DV-NIZK.Ver) with the following properties:
crs ←DV-NIZK.Setup(1^{λ}): On input the security parameter λ, the setup algorithm outputs a common reference string crs.
(pk, sk)←-DV-NIZK.Keygen(crs): On input x common reference string crs, the key-generation algorithm outputs a public key pk and a secret verification key sk which is sent only to the verifier.
π<DV-NIZK.Prove(crs, pk, x, w): On input the common reference string crs, a public key pk, a statement a, and a witness w, the prove algorithm outputs a proof π.
{0,1}←DV-NIZK. Ver(crs, sk, x, π): On input the common reference string crs, a secret key sk, a statement x, and a proof T, the verification algorithm outputs a bit b∈{0,1}.

Moreover, DV-NIZK should satisfy the following properties:
Completeness: For all (x, w)∈ [symbol] , we have that

$$Pr [ \text{} DV - NIZK . Ver ( crs , sk , x , π ) = 1 \vert π ← DV - NIZK . Prove ( crs , pk , x , w ) , \text{} crs ← DV - NIZK . Setup ( {1}^{λ} ) , \text{} ( pk , sk ) ← DV - NIZK . Keygen ( crs ) ] = 1.$$

Soundness: We consider two variants of soundness:
   Non-adaptive soundness: For all x∉L, all PPT adversaries [symbol] , there exists a negligible function neg|(·) such that

$$Pr [ π ← {𝒜}^{DV - NIZK . Ver ( crs , sk , \cdot )} ( {1}^{λ} , crs , pk , x ) : DV - NIZK . Ver ( crs , sk , x , π ) = 1 ] = negl ( λ ) ,$$

where crs←DV-NIZK.Setup(1^{λ}) and (pk, sk)←DV-NIZK.Keygen(crs).
Adaptive soundness: For all PPT adversaries [symbol] , there exists a negligible function neg|(·) such that

$$Pr [ ( x , π ) ← {𝒜}^{DV - NIZK . Ver ( crs , sk , \cdot )} ( {1}^{λ} , crs ) : x ∉ L ∧ DV - NIZK . Ver ( crs , sk , x , π ) = 1 ] = negl ( λ ) ,$$

$$where$$

$$( crs , pk , sk ) ← DV - NIZK . Setup ( {1}^{λ} ) and$$

$$( pk , sk ) ← DV - NIZK . Keygen ( crs ) .$$

Computational Zero-knowledge: For all PPT adversaries [symbol] , there exists a PPT simulator S=(S₁, S₂) and negligible function neg|(·) such that

$$\vert Pr [ {𝒜}^{{𝒪}_{0} ( crs , pk , \cdot } ) ( crs , pk , sk ) = 1 ] - Pr [ {𝒜}^{{𝒪}_{1} ( {st}_{𝒮} , sk , \cdot )} ( crs , pk , sk ) = 1 ] \vert = negl ( λ ) ,$$

where crs←DV-NIZK.Setup(1^{λ}), (pk, sk)←DV-NIZK.Keygen(crs), and (st_{S}, crs, pk, sk)←S₁ (1^{λ}), the oracle [symbol] ₀(crs, pk, w) outputs DV-NIZK.Prove(crs, pk, x, w) if (x, w)∈ [symbol] and ⊥otherwise, and the oracle [symbol] ₁(st_{S}, x) outputs S₂ (st_{S}, x) if (x, w)∈ [symbol] and ⊥ otherwise.
Statistical Zero-knowledge: For all adversaries [symbol] , there exists a PPT simulator S=(S₁, S₂) and negligible function neg|(·) such that

$$\vert Pr [ {𝒜}^{{𝒪}_{0} ( crs , pk , \cdot } ) ( crs , pk , sk ) = 1 ] - Pr [ {𝒜}^{{𝒪}_{1} ( {st}_{𝒮} , sk , \cdot )} ( crs , pk , sk ) = 1 ] \vert = negl ( λ ) ,$$

where crs←DV-NIZK.Setup(1^{λ}), (pk, sk)←DV-NIZK.Keygen(crs), and (st_{S}, crs, pk, sk)←S₁ (1^{λ}), the oracle [symbol] ₀(crs, pk, w) outputs DV-NIZK. Prove(crs, pk, x, w) if (x, w)∈ [symbol] and ⊥ otherwise, and the oracle [symbol] ₁(st_{S}, x) outputs S₂ (st_{S}, x) if (x, w)∈ [symbol] and ⊥ otherwise.
3 Secret Sharing with Randomness Recovery

A key ingredient in our ABSFE construction is a secret sharing scheme for non-monotone functions with a randomness recovery property.

A secret sharing scheme for non-monotone functions is a generalization of the standard secret sharing which applies to arbitrary (not necessarily monotone functions). In such a scheme, the shares consist of 2 [symbol] values (s₁, t₁, s₂, t₂, . . . , [symbol] , [symbol] ) and for any input (x₁, . . . , [symbol] )∈ [symbol] , the collection of shares {sᵢ:xᵢ=1}∪{tᵢ: xᵢ=0} determines the secret if F(x₁, . . . , [symbol] )=1 and does not reveal anything otherwise. The randomness recovery property requires a procedure that recovers all the 2 [symbol] shares from [symbol] shares in the case where F is satisfied.

Analogously to standard secret sharing, we refer to x as an authorized set of users if F(x)=1 and unauthorized otherwise. Further, when x is authorized, the corresponding shares, i.e., {sᵢ: xᵢ=1}∪{tᵢ: xᵢ=0} are referred to as the authorized shares.

Remark 3.1. A secret sharing scheme for non-monotone functions captures the case where parties are partitioned into pairs, and we care about coalitions where exactly one party from each pair is present. This notion was studied in the past in several works. The additional randomness recovery property that we require is new to our work.

Definition 3.2 (Secret sharing with randomness recovery (RR-SS)). A secret sharing scheme with randomness recovery for a function family [symbol] ={F: [symbol] → [symbol] with secret space [symbol] and share space [symbol] is defined as a tuple SS-RR=(SS-RR.GenShares, SS-RR.Reconstruct, SS-RR.Regenerate) such that
(a_{1,0}, a_{1,1}, . . . , [symbol] ₀, [symbol] ₁)←SS-RR. GenShares(F,s): A randomized share generation algorithm that takes as input the function F∈ [symbol] , the secret s∈ [symbol] , and it outputs shares (a_{i,o}, a_{i,1}, . . . , [symbol] ₀, [symbol] ₁)← [symbol] .
s←SS-RR. Reconstruct(F,(a_{1,0}, a_{1,1}, . . . , [symbol] ₀, [symbol] ₁)): A deterministic algorithm that takes as input the function F∈ [symbol] , 2 [symbol] shares (a_{1,0}, a_{1,1}, . . . , [symbol] ₀, [symbol] ₁), and outputs a secret s∈ [symbol] .
(b_{1,0}, b_{1,1}, . . . , [symbol] ₀, [symbol] ₁)←SS-RR.Regenerate(F,(y₁, . . . , y_{T})): (To be syntactically correct, we can assume that SS-RR. Regenerate has 2 [symbol] +1 ordered input slots and the remaining 2 [symbol] −T slots are set as ⊥.) A deterministic algorithm that on input a function F∈ [symbol] and shares {yᵢ}_{i∈T} for any T≤2 [symbol] , and outputs shares(b_{1,0}, b_{1,1}, . . . , [symbol] ₀, [symbol] ₁)∈ [symbol] ∪{⊥}.

The share size of a scheme as above is defined to be ┌log [symbol] ┐.

Definition 3.3 (Efficiency). For any function F∈ [symbol] let |F| denote the length of the description of F, then,.
SS-RR.GenShares runs in time poly(|F|, ┌log [symbol] ┐).
SS-RR.Reconstruct runs in time poly(|F|, [symbol] , ┌log | [symbol] ┐).
SS-RR.Regenerate runs in time poly(|F|, [symbol] , ┌log | [symbol] ┐).

The correctness of a secret sharing scheme for a family class [symbol] as above is captured by the following property.

Definition 3.4 (Correctness). For any function F∈ [symbol] , and any secret s∈ [symbol] ,
Reconstruction correctness:

$$Pr [ SS - RR \cdot Reconstruct ( F , ( {a}_{1 , 0} , {a}_{1 , 1} , … , {a}_{l , 0} , {a}_{l , 1} ) ) = s ] = 1 ,$$

where the probability is over the randomness used for sampling (a_{i,o}, a_{i,1}, . . . , [symbol] ₀, [symbol] ₁)←SS-RR.GenShares(F,s).
Regeneration correctness: for all x∈ [symbol] such that F(x)=1,

$$P r [ SS - RR \cdot Regenerate ( F , ( {a}_{1 , {x}_{1}} , … , {a}_{l , {x}_{l}} ) ) = ( {a}_{i , 0} , {a}_{i , 1} , … , {a}_{l , 0} , {a}_{l , 1} ) ] = 1 ,$$

where the probability is over the randomness used for sampling (a_{1,0}, a_{1,1}, . . . , [symbol] ₀, [symbol] ₁)←SS-RR.GenShares(F,s).

In other words, if (a_{i,o}, a_{i,1}, . . . , [symbol] ₀, [symbol] ₁) was generated honestly by the share generation algorithm, then every set of authorized shares must regenerate exactly the set of shares (a_{i,o}, a_{i,1}, . . . , [symbol] ₀, [symbol] ₁).

Definition 3.5 (Perfect privacy). For any access function F and any input x such that F(x)=0, for any two secret s₁, s₂∈ [symbol] , the distributions

$${( {a}_{i , {x}_{i}} )}_{i ∈ ℓ} and {( {a}_{i , {x}_{i}}^{′} )}_{i ∈ ℓ}$$

are identical, where (a_{i,o}, a_{i,1}, . . . , [symbol] ₀, [symbol] ₁)←SS-RR.GenShares

$$( F , {s}_{1} ) and ( {a}_{i , 0}^{′} , {a}_{i , 1}^{′} , … , {a}_{ℓ , 0}^{′} , {a}_{ℓ , 1}^{′} ) ← SS - RR . GenShares ( F , {s}_{2} ) .$$

Lastly, we formalize the soundness property of the Regenerate procedure. In short, it says that every (potentially maliciously generated) set of shares are either invalid, or correspond to some legal sharing of some secret (meaning they are valid).

Definition 3.6 (Soundness of Regenerate). For any function F∈ [symbol] , for all set of (maliciously generated) shares (a_{1,0}, a_{1,1}, . . . , [symbol] ₀, [symbol] ₁)∈ [symbol] , for all subsets of shares (z₁, . . . , z_{T}) for T≤2 [symbol] such that for some x∈{0, [symbol] : F(x)=1, ∀ᵢ∈[ [symbol] ], a_{i,x}_{ᵢ}∈(z₁, . . . , z_{T}),
either SS-RR.Regenerate(F,(z₁, . . . , z_{T}))=⊥;
or ∃s ∈ [symbol] , ∃r: SS-RR.Regenerate(F,(z₁, . . . , z_{T}))=SS-RR.GenShares(F,s;r).

$$M oreover , iff s ϵ P , r such that SS - RR GenShares ( F , s ; r ) = ( {a}_{1 , 0} , {a}_{1 , 1} , … , {a}_{l , 0} , {a}_{l , 1} ) , then SS - RR \cdot Regenerate ( F , ( {a}_{1 , 0} , {a}_{1 , 1} , … , {a}_{l , 0} , {a}_{l , 1} ) ) = ⊥$$

### 3.1 A Construction for Polynomial-Size Branching Programs

We construct such a secret sharing scheme for all functions functions that can be computed by polynomial-sized branching programs (PBP).

Definition 3.7 (Branching Programs of size [symbol] ) A size [symbol] branching program is a Directed Acyclic Graph (DAG) G with the following properties:
The graph G has [symbol] +2 nodes.
There exists a designated source node, call it v₁.
There are 2 sink nodes denoted by v_{acc} and vᵣₑⱼ with no outgoing edges. All non sink nodes labelled {v₁, . . . , [symbol] } have exactly two outgoing edges labelled (i, b), for i∈[ [symbol] ] and b∈{0, 1}. Without loss of generality, assume that [symbol] ₊₁=v_{acc} and [symbol] ₊₂=vᵣₑⱼ.
Every directed path in G must either terminate at v_{acc} OT vᵣₑⱼ.

Definition 3.8 (Functions solvable by Polynomial Branching Programs). A function F:{0, 1}ⁿ→{0, 1}is solvable by a size [symbol] branching program G if there is a mapping μ:{0, 1}ⁿ→ [symbol] such that for all inputs x∈{0, 1}ⁿand y=μ(x):
the set of edges [symbol] in G forms a directed path from v₁ to v_{acc} if F(x)=1, and
the set of edges [symbol] in G forms a directed path from v₁ to v_{acc} if F(x)=0. G is said to be polynomial sized if (E poly(n).

Definition 3.9 (Complexity Class (PBP)). PBP is the class of decision problems which are solvable by a polynomial sized branching program.

We now present the construction of a secret sharing scheme for PBP. We assume every function F∈PBP is represented as a polynomial sized branching program.

Intuition. To share a secret s, we assign s to the accept sink node. The source and reject sink node are assigned the value 0. Every other node is assigned uniform random value. The share corresponding to each edge (hence the parties) is the difference between the values of the nodes at both ends. Clearly, if one has a path from the source node to the accept sink node, then adding the shares along the path will yield the correct secret s. Intuitively, regeneration correctness follows from the observation that (1) we always know the share corresponding to at least one outgoing edge from every node, and (2) for every node directly connected to a sink with an edge, once we know the secret, and the share corresponding to one outgoing edge from it, then we can simply add these two values to get the random value assigned to the node. This step can be repeated iteratively to extract all the shares. In our construction we work with [symbol] = [symbol] ={0, 1}^{p} We proceed with the full details.
SS-RR.GenShares(F,s):
   1. Assign values to every node [symbol] _{+2]} to [symbol] _{+2]};

$$\begin{matrix}if i = 1 or i = l + 2 , then {val}_{i} = 0 \\ if i = l + 1 then {val}_{i} = s \\ else {val}_{i} {\{ 0 , 1 \}}^{p}\end{matrix}$$

2. Define the shares [symbol] _{b∈{0,1}} as follows: if edge labelled (i, b) is directed from node vᵢ to vⱼ, then set a_{i,b}=valⱼ−valᵢ
   3. output [symbol] _{b∈{0,1}}
SS-RR.Reconstruct(F,(a_{1,0}, a_{1,1}, . . . , [symbol] ₀, [symbol] ₁)):
   1. Perform Depth First Search to find a directed path from v₁ to v_{acc} in F. Denote the path by E.
   2. If no path exists from v₁ to v_{acc}, then output L and terminate.
   3. OutputΣ_{(j,b)∈E}a_{j,b}.
SS-RR.Regenerate(F,(y, . . . , y_{T})):
   1. Interpret yᵢ as a_{j,b} in the correct order with appropriate indices for some j∈[ [symbol] ] and b∈{0, 1}. Add the edge (j, b) to setE
   2. Construct a DAG with [symbol] +2 nodes and edge set E.
   3. If no path exists from v₁ to v_{acc}, then output L and terminate.
   4. Perform a Depth First Search to find a path E′ from vᵢ to v_{acc}.

$$\begin{matrix}5. va {l}_{l + 1} = {\sum }_{( j , b ) ∈ {E}^{′}} {a}_{j , b} \\ 6. {val}_{l + 2} = v a {l}_{1} = 0\end{matrix}$$

7. Let nᵥ_{ᵢ} be the minimum length of a directed path from v to either v_{acc} Or vᵣₑⱼ.
   8. Do the following iteratively for all k=1 to [symbol]
      (a) For all nodes v such that nᵥ_{ᵢ}=k
         i. Let vⱼ be any node which has the directed edge (i, b) from vᵢ such that

$${n}_{{v}_{j}} = k - 1 and {a}_{i , b} ∈ {\{ {y}_{i} \}}_{i ∈ T} ii . {val}_{i} = v a {l}_{j} - {a}_{i , b}$$

9. For all i, j, if edge labelled (i, b) is directed from node vᵢ to vⱼ, then set

$${a}_{i , b}^{′} = {val}_{j} - {val}_{i}$$

10. If ∃(j,b)∈E such that

$${a}_{j , b} \neq {a}_{j , b}^{′} ,$$

then output ⊥
11. Else output

$$( {a}_{1 , 0}^{′} , {a}_{1 , 1}^{′} , … , {a}_{l , 0}^{′} , {a}_{l , 1}^{′} )$$

### Efficiency:

Lemma 3.10. For any function F∈ [symbol] , secret/share space {0, 1}^{p}, SS-RR. GenShares, SS-RR.Reconstruct and SS-RR.Regenerate all run in time poly(|F|, p).

The proof follows by observing that Depth First Search can be done in polynomial time in the size of function F, and all other operations in the algorithms run in polynomial time in the length of their respective inputs.

### Reconstruction Correctness:

Lemma 3.11. For any function F∈PBP and secret s∈ [symbol] ,

$$Pr [ SS - RR \cdot Reconstruct ( F , ( {a}_{1 , 0} , {a}_{1 , 1} , … , {a}_{l , 0} , {a}_{l , 1} ) ) = s ] = 1 ,$$

where the probability is over the randomness used for sampling (a_{i,o}, a_{i,1}, . . . , [symbol] ₀, [symbol] ₁)←SS-RR.GenShares(F, s). Here SS-RR.Reconstruct and SS-RR.GenShares are as presented in the above construction.
Proof. By the correctness of Depth First Search, E contains v₁ and v_{acc}, and a sequence of edges [symbol] for some b∈{0, 1} which starts from v₁ and ends at v_{acc}. Let {a_{j,b}}_{(j,b)∈E} be the shares corresponding to these edges in the path.

Let us assume that the length of path E is t for some t≤ [symbol] . Let u₁, . . . , uₜ denote the nodes in E in the correct order, i.e., u₁=v₁, uₜ=v_{acc} and there is an edge in E from uᵢ to uᵢ₊₁. Let

$${val}_{i}^{′}$$

be the value assigned to node uᵢ by the algorithm GenShares. Therefore as per construction of GenShares,

$${\sum }_{( j , b ) ∈ E} {a}_{j , b} = {\sum }_{i ∈ \vert t \vert} ( {val}_{i + 1}^{′} - {val}_{i}^{′} ) = {val}_{t}^{′} - {val}_{1}^{′} = {val}_{a c c} - v a {l}_{1} = s .$$

Thus, we prove a stronger statement that for all randomness r,

$$SS - RR \cdot Reconstruct ( F , ( {a}_{1 , 0} , {a}_{1 , 1} , … , {a}_{l , 0} , {a}_{l , 1} ) ) = s ,$$

where r is the internal randomness used by SS-RR. GenShares.

### Regeneration Correctness:

Lemma 3.12. For all functions F∈cF and x∈ [symbol] such that F(x)=1,

$$Pr [ SS - RR \cdot Regenerate ( F , ( {a}_{1 , {x}_{1}} , … , {a}_{l , {x}_{l}} ) ) = ( {a}_{i , 0} , {a}_{i , 1} , … , {a}_{l , 0} , {a}_{l , 1} ) ] = 1 ,$$

Here SS-RR.Regenerate and SS-RR. GenShares are as presented in the above construction.

### Perfect Privacy:

Lemma 3.13. For any function F and any input x such that F(x)=0, for any two secret s₁, s₂∈ [symbol] , the distributions [symbol] and

$${( {a}_{i , {x}_{i}}^{′} )}_{i ∈ ℓ}$$

are identical, where (a_{i,0}, a_{i,1}, . . . , [symbol] ₀, [symbol] ₁)←SS-RR.GenShares(F,s₁) and

$$( {a}_{i , 0}^{′} , {a}_{i , 1}^{′} , … , {a}_{ℓ , 0}^{′} , {a}_{ℓ , 1}^{′} ) ← SS - RR . GenShares ( F , {s}_{2} ) .$$

### Regeneration Soundness

Lemma 3.14. For any function F∈ [symbol] , for all set of (maliciously generated) shares(a_{1,0}, a_{1,1}, . . . , [symbol] ₀, [symbol] ¹)∈ [symbol] , for all subsets of shares (z₁, . . . , z_{T}) for T≤2 [symbol] such that for some x∈ [symbol] : F(x)=1, ∀i∈[ [symbol] ], a_{i,x}_{ᵢ}∈(z₁, . . . , z_{T}),
either SS-RR.Regenerate(F,(z₁, . . . , z_{T}))=⊥;
or ∃s∈ [symbol] , ∃r: SS-RR.Regenerate(F,(z₁, . . . , z_{T}))=SS-RR. GenShares(F,s; r).

Moreover, iff [symbol] s∈ [symbol] ,r such that SS-RR. GenShares(F,s; r)=(a_{1,0}, a_{1,1}, . . . , [symbol] ₀, [symbol] ₁), then

$$SS - RR \cdot Regenerate ( F , ( {a}_{1 , 0} , {a}_{1 , 1} , … , {a}_{l , 0} , {a}_{l , 1} ) ) = ⊥$$

Thus, we get the following theorem:

Theorem 3.15 (Efficient secret sharing for non-monotone functions with randomness recovery for functions in (PBP)). There exists an efficient secret sharing scheme with randomness recovery satisfying perfect reconstruction correctness, perfect regeneration correctness, perfect privacy and regeneration soundness for any access function F∈PBP.

A computational monotone secret sharing scheme with randomness recovery. Additionally, we also construct a randomness-recoverable monotone secret sharing scheme with computational privacy in Appendix??. The construction relies on a primitive called Targeted Lossy Pseudorandom Generators (see Definition??) which can be constructed from one-way function. We believe such a scheme can be of independent interest, but postpone the details to the appendix.

Remark 3.16 (Comparison with prior work). Hajiabadi et al. introduce the notion of randomness recoverable secret sharing schemes both in the information theoretic and computational regimes. Our DAG based information theoretic construction is incomparable to their work as our scheme works for a non-monotone access structure, and therefore it is not really a secret sharing scheme in the usual sense. On the other hand, our computational LSSS is a strictly weaker object because it needs a Setup algorithm to generate the secret along with the shares. On the positive side, we can show that such an LSSS with setup suffices to construct ABSFE which in turn implies DV-NIZK for NP, and we can construct them directly from One-Way functions. Note that the construction in prior work relies on either a one-time KDM secure SKE or hinting PRGs which are not known to be implied by One-Way functions.

### 4 The ABSFE Construction

In this section we lay out the details of our ABSFE construction for some function ƒ: [symbol] →{0, 1}. Our construction uses the following building blocks in a black-box manner:
A length parameterized lossy trapdoor function family LTDF=(LTDF.Setup, LTDF.AltSetup, LTDF.Eval) with input length δ and lossiness parameter λ₁. See Section 2.2 and Theorem 2.4.
A non-monotone secret sharing scheme with randomness recovery SS-RR=(SS-RR.GenShares, SS-RR.Reconstruct, SS-RR.Regenerate) for ƒ with long secret and shares in {0, 1}^{δ}. See Section 3 and Theorem 3.15.
A pairwise independent hash function family [symbol] ={H:{0, 1}^{δ}→{0, 1}^{λ}} where

$$γ < δ - 2 l {γ}_{1} - 2 log ( \frac{1}{n e g 1 ( λ )} ) .$$

Here λ is the security parameter for the scheme. See Definition 2.1.

We summarize the various parameters used in our construction in the table below:

| Parameter | Notation |
|---|---|
| Security parameter | λ |
| Length of ABSFE key and | [symbol] |
| Length of plaintext message and output | γ |
| length of hash function | |
| Input length to the hash function and LTDF | δ |
| Lossiness parameter of LTDF | γ₁ |

### 4.1 Construction

As mentioned, we rely on the following primitives in a black box manner: a length-parametrized lossy trapdoor function family, a pairwise independent hash function family, and a non-monotone secret sharing scheme with randomness recovery.

Notation: For any bit b∈{0, 1}, b̅ denotes 1−b∈{0, 1}. For any function ƒ with two inputs, say (x, k), ƒₓ is the function which is hardcoded with x which upon input k satisfies the property that for all (x, k), ƒ(x, k)=ƒₓ(k).
ABSFE.Setup(1^{λ}):
   1. Sample [symbol] < [symbol]
   2. Output pp:=H
ABSFE.Keygen (pp, k∈ [symbol] ):

$$\begin{matrix}1. & ∀ i ∈ ( \vert l \vert , ( {ev}_{i , {k}_{i}} , t {d}_{i , {k}_{i}} ) ← LTDF \cdot Setup ( {1}^{λ} , {1}^{δ} ) \\ 2. & ∀ i ∈ ( \vert l \vert , e {v}_{i , \overline{{k}_{i}}} ← LTDF \cdot AltSetup ( {1}^{λ} , {1}^{δ} ) \\ 3. & pk ← {\{ e {v}_{i , b} \}}_{i ∈ \vert l \vert b ∈ \{ 0 , 1 \}} \\ 4. & sk := ( k , {\{ t {d}_{i , {k}_{i}} \}}_{i ∈ l} ) \\ 5. & msk := sk\end{matrix}$$

6. Output (pk, sk)
ABSFE.Enc(pp, pk, x∈{0, 1}^{λ}, m∈{0, 1}^{λ}):

$$1. s {←}^{\$} {\{ 0 , 1 \}}^{δ}$$

$$2. ( {a}_{i , 0} , {a}_{i , 1} , … , {a}_{ℓ , 0} , {a}_{ℓ , 1} ) ← SS - RR . GenShares ( {f}_{x} , s )$$

$$3. ∀ j ∈ ℓ , b ∈ \{ 0 , 1 \} , {ct}_{j , b} ← LTDF . Eval ( {ev}_{j , b} , {a}_{j , b} )$$

$$4. {ct}_{0} ← m ⊕ H ( s )$$

$$5. Output ct := ( {ct}_{0} , {\{ {ct}_{j , b} \}}_{j ∈ [ ℓ ] , b ∈ \{ 0 , 1 \}} )$$

ABSFE.Dec(pp,sk, x, ct):

$$1. If f ( x , k ) = 0 , then output ⊥$$

$$2. for all j ∈ [ ℓ ] , let {a}_{j , {k}_{j}}^{′} ← LTDF . Invert ( {td}_{j , {k}_{j}} , {ct}_{j , {k}_{j}} )$$

$$3. ( {\tilde{a}}_{1 , 0} , {\tilde{a}}_{1 , 1} , … , {\tilde{a}}_{ℓ , 0} , {\tilde{a}}_{ℓ , 1} ) ← SS - RR . Regenerate ( {f}_{x} , {\{ {a}_{j , {k}_{j}}^{′} \}}_{j ∈ [ ℓ ]} )$$

$${4. {s}^{′} ← SS - RR . Reconstruct ( {f}_{x} , {a}_{j , b} \}}_{j ∈ [ ℓ ] , b ∈ \{ 0 , 1 \}} )$$

5. If ∃j∈[ [symbol] ], b∈{0, 1}, such that LTDF.Eval(ev_{j,b}, ã_{j,b})≠ct_{j,b}, then output ⊥
   6. Else, output ct₀⊕H(s′)
      5 DV-NIZK from ABSFE

We briefly recall the main theorem of prior work which shows that DV-NIZKs can be constructed in a black-box manner from ABSFE. We present their main theorem and show how it can be extended to get DV-NIZK with statistical zero-knowledge if the underlying ABSFE satisfies statistical message-hiding.

Designated Verifier NIZKs from ABSFE: Let [symbol] ⊆{0, 1}ⁿ be an NP language associated with NP relation [symbol] ⊆{0, 1}ⁿ×{0, 1}^{h}. A DV-NIZK for [symbol] relies on the following building blocks:
A semi-malicious zero-knowledge PCP zkPCP=(zkPCP.Prove, zkPCP.Query, zkPCP.Ver) for [symbol] . Let m be the length of the PCP and ρ be a bound on the number of random bits needed for zkPCP.Query.
A pseudorandom function PRF: [symbol] ×{0, 1}ⁿ→{0, 1}^{ρ}.
An attribute-based secure function evaluation scheme ABSFE=(ABSFE.Setup, ABSFE.Keygen, ABSFE.Enc, ABSFE.Dec) with weak message hiding and strong key hiding for function F which is defined below.

Function for ABSFE: Let [symbol] ={ƒ:{0, 1}^{λ}× [symbol] →{0, 1}} be the function family where

$$f ( ( x , t ) , k ) = \{ \begin{matrix}1 if t ∈ [ Q ] \\ 0 otherwise\end{matrix} .$$

Here, (stₓ, [symbol] )←zkPCP.Query (x; PRF(k,x)).

See prior work for detailed construction and proofs. We present their main theorem below.
Theorem 5.1. If there exists attribute-based secure function evaluation (ABSFE) with weak message hiding and strong key hiding, semi-malicious zkPCP for NP, and a pseudorandom function, then there exists reusable non-adaptively sound DV-NIZK argument for NP.

Observe that in the theorem statement of prior work, the ABSFE and the zero-knowledge PCP satisfy computational weak message hiding and computational zero-knowledge respectively. The final conclusion also yields a DV-NIZK argument with computational ZK. However, the result can be easily extended to achieve DV-NIZK with statistical zero-knowledge if the aforementioned properties are made statistical. In particular, we prove the following thoeorem:
Theorem 5.2. Let λ∈ [symbol] be the security parameter. For all n, ρ=poly(λ), if there exists
a semi-malicious statistical zero-knowledge PCP zkPCP=(zkPCP.Prove, zkPCP.Query, zkPCP.Ver) for NP. Let ρ be a bound on the number of random bits needed for zkPCP.Query,
a pseudorandom function PRF:{0, 1}^{λ}×{0, 1}ⁿ→{0, 1}^{ρ}, and
an attribute-based secure function evaluation scheme ABSFE=(ABSFE.Setup, ABSFE.Keygen, ABSFE.Enc, ABSFE.Dec) with weak statistical message hiding and strong key hiding for function F defined above, then there exists reusable non-adaptively sound DV-NIZK argument with statistical zero-knowledge for NP.

### System Implementations

### System Overview and Core Process Flow

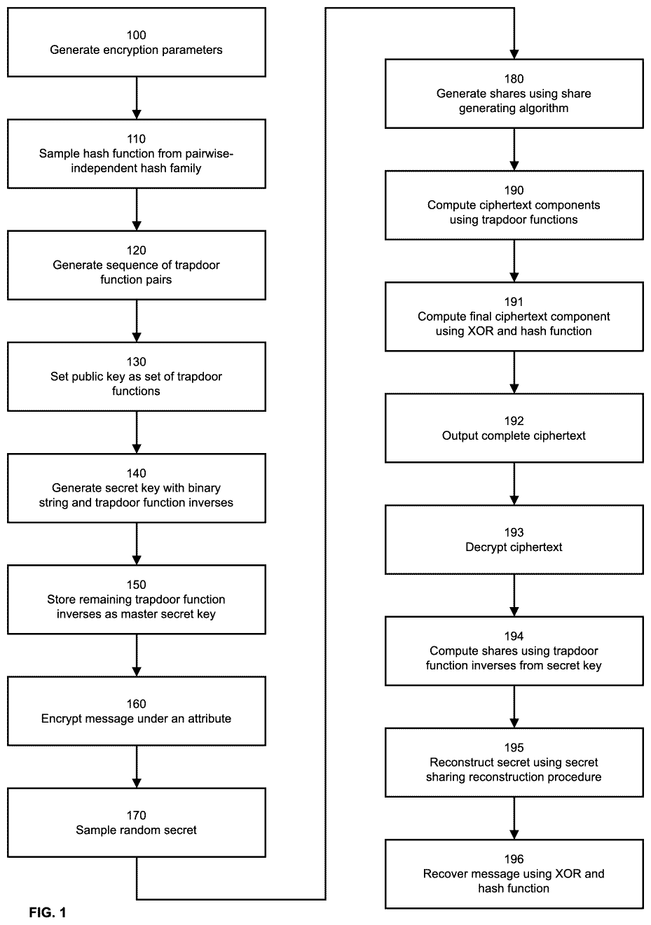

Referring to FIG. 1, a communication system 100 implements secure attribute-based encryption with function hiding properties through a comprehensive process flow that establishes mathematical frameworks and operational procedures. The communication system 100 begins with step 110, which involves sampling a hash function from a pairwise-independent hash family. This hash function H serves as a public parameter and forms part of the foundational cryptographic infrastructure. The pairwise-independent hash family provides statistical properties that ensure the entropy of random secrets remains sufficiently high given ciphertext components, thereby preventing statistical attacks against the encryption scheme. In some cases, the hash function H may be selected from families such as universal hash functions or other cryptographically secure hash constructions that maintain the pairwise independence property across different input pairs. The process continues to step 120, where a sequence of trapdoor function pairs

$$( {g}_{i , b} , {g}_{i , b}^{- 1} )$$

for i∈[n] and b∈{0, 1} are generated, where n represents a positive integer parameter. These trapdoor function pairs form the mathematical foundation for the encryption and decryption operations. The trapdoor functions may be generated using lossy trapdoor function setup algorithms that enable efficient sampling in either lossy or injective modes. In the injective mode, the trapdoor function pairs

$$( {g}_{i , b} , {g}_{i , b}^{- 1} )$$

are efficiently computable and invertible with knowledge of the trapdoor information. The lossy mode provides computational security properties by making the functions statistically lossy, meaning that the range of the function becomes significantly smaller than the domain, thereby hiding information about the inputs.

As shown in FIG. 1, step 130 establishes a public key pk as the set of trapdoor functions {g_{i,b}}_{i∈[n],b∈{0,1}}. This public key structure enables the encryption process to operate without revealing the specific trapdoor information while maintaining the ability to perform the forward direction of the trapdoor functions. The public key may be distributed to encryption devices and stored in memory systems for subsequent use in encryption operations. Step 140 generates a secret key sk comprising a binary string ƒ of length n and a set of trapdoor function inverses

$${\{ {g}_{i , {f}_{i}}^{- 1} \}}_{i ∈ [ n ]} ,$$

where ƒᵢ represents the i-th bit of the binary string ƒ. The secret key structure enables selective access to specific trapdoor function inverses based on the binary representation encoded in the string ƒ, thereby implementing attribute-based access control mechanisms.

With continued reference to FIG. 1, step 150 stores the remaining trapdoor function inverses as a master secret key in memory. This master secret key contains the trapdoor function inverses that are not included in individual secret keys, enabling a hierarchical key management structure. The master secret key may be maintained by a trusted authority or key management system that can generate additional secret keys for different attributes or access policies. Step 160 initiates the encryption phase by receiving a message m and an attribute a for encryption. The attribute a and the binary string ƒ represent inputs to a function F(x, ƒ), where decryption succeeds if and only if F(x, ƒ)=1, thereby implementing attribute-based access control mechanisms that determine which secret keys can successfully decrypt ciphertexts encrypted under specific attributes.

The encryption process advances to step 170, where a random secret s is sampled and stored in memory. This random secret s serves as the foundation for the secret sharing scheme and provides the randomness necessary for semantic security of the encryption scheme. Step 180 generates shares (a_{1,0}, a_{1,1}, . . . , a_{n,0}, a_{n,1}) using a share generating algorithm executed by a processor. The share generating algorithm implements a secret sharing scheme for non-monotone functions, allowing reconstruction of the secret s from an authorized subset of the shares. In some cases, the secret sharing scheme may utilize linear secret sharing schemes, threshold secret sharing, or more advanced constructions that support complex access structures and non-monotone Boolean functions.

As further shown in FIG. 1, step 190 computes ciphertext components ct_{i,b}=g_{i,b}(a_{i,b}) for i∈[n] and b∈{0, 1} using the processor. These ciphertext components represent the application of the trapdoor functions to the generated shares, creating the encrypted representation of the secret sharing information. The computation of ciphertext components may involve modular arithmetic operations, elliptic curve computations, or other mathematical operations depending on the specific trapdoor function construction employed. Step 191 computes a final ciphertext component ct₀=m ⊕H(s), where ⊕ denotes bitwise XOR operation. This final ciphertext component combines the original message m with the hash of the random secret s, creating a one-time pad construction that provides information-theoretic security for the message content given the secrecy of the random secret s.

The encryption process concludes with step 192, which assembles a complete ciphertext as (ct₀, {ct_{i,b}}_{i∈[n],b∈{0,1}}) and stores the complete ciphertext in a storage device. The complete ciphertext structure encapsulates both the encrypted message component and the encrypted secret sharing components, enabling subsequent decryption operations by authorized parties. The complete ciphertext may be transmitted via network interface devices to decryption systems or stored in distributed storage systems for later retrieval and decryption.

The decryption phase begins with step 193, where the complete ciphertext is processed for decryption. Step 194 computes shares

$${a}_{i , {f}_{i}} = {g}_{i , {f}_{i}}^{- 1} ( {ct}_{i , {f}_{i}} )$$

for trapdoor function inverses

$${g}_{i , {f}_{i}}^{- 1} ∈ sk$$

contained in the secret key. This computation applies the trapdoor function inverses to the corresponding ciphertext components, recovering the shares that were originally generated during the encryption process. The successful computation of shares depends on the availability of the appropriate trapdoor function inverses in the secret key, which is determined by the attribute-based access control function F(x, ƒ). Step 195 reconstructs the secret s using a secret sharing reconstruction procedure on the computed shares. The reconstruction procedure may involve linear algebra operations, polynomial interpolation, or other mathematical techniques depending on the specific secret sharing scheme implementation.

The decryption process concludes with step 196, which recovers the message as m=ct₀⊕H(s) using the reconstructed secret s. This message recovery operation reverses the one-time pad construction applied during encryption, yielding the original message m. The communication system 100 implements function hiding properties, wherein an adversary with access to the complete ciphertext and the message cannot distinguish between two different implementations of encryption functions that produce the same input-output behavior. These function hiding properties ensure that the specific access structure or attribute relationships remain concealed from adversaries, providing additional privacy protection beyond the confidentiality of the encrypted message content.

### Communication System Architecture

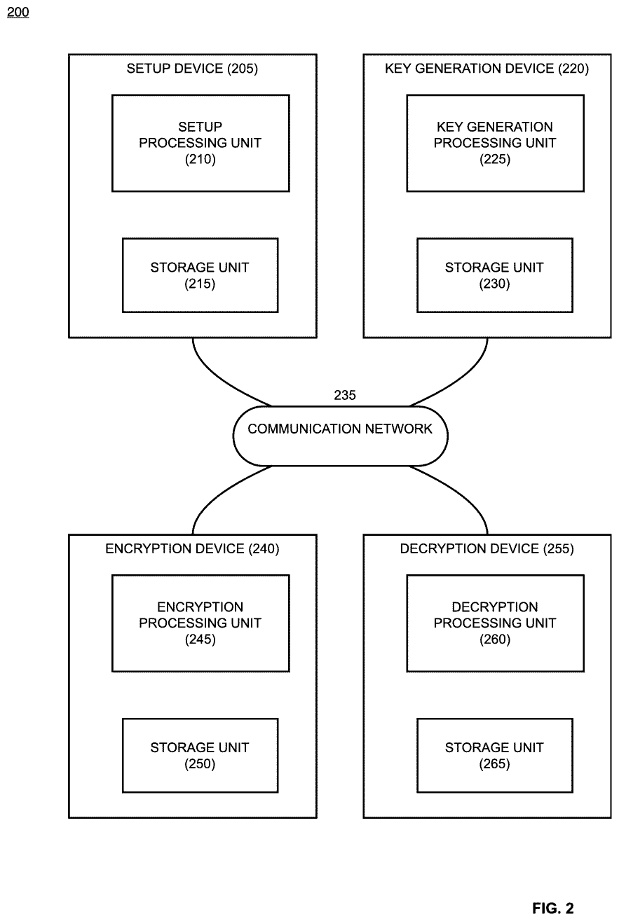

Referring to FIG. 2, a communication system 200 provides a distributed architecture for implementing secure attribute-based encryption with function hiding properties. The communication system 200 comprises multiple specialized devices that work in coordination to execute cryptographic operations across a networked environment. The distributed nature of the communication system 200 allows for separation of cryptographic responsibilities, enhancing security through compartmentalization of sensitive operations and data storage. In some cases, the communication system 200 may be deployed across geographically distributed locations to provide redundancy and fault tolerance for cryptographic services.

The communication system 200 includes a setup device 205 that serves as the foundation for establishing cryptographic parameters and public system configurations. A setup processing unit 210 within the setup device 205 executes parameter generation algorithms and manages the initialization of cryptographic primitives. The setup processing unit 210 may comprise specialized hardware components optimized for cryptographic computations, including random number generators and mathematical coprocessors. A storage unit 215 associated with the setup device 205 maintains public parameters, system configuration data, and initialization vectors that are distributed to other components within the communication system 200. The storage unit 215 may implement secure storage mechanisms to protect against unauthorized access to system parameters while allowing controlled distribution to authorized devices.

A key generation device 220 operates within the communication system 200 to manage the creation and distribution of cryptographic keys for authorized entities. The key generation device 220 incorporates a key generation processing unit 225 that executes algorithms for generating secret keys, master secret keys, and associated cryptographic material. The key generation processing unit 225 may implement hardware security modules or trusted execution environments to protect key generation processes from external observation or tampering. A storage unit 230 within the key generation device 220 maintains generated keys, key metadata, and access control information that determines which entities may receive specific cryptographic keys. In some cases, the storage unit 230 may implement hierarchical key storage structures that allow for efficient key derivation and management across multiple security domains.

The communication system 200 further includes a communication network 235 that interconnects the setup device 205, key generation device 220, and other system components. The communication network 235 facilitates secure data exchange between distributed devices while maintaining the integrity and confidentiality of transmitted cryptographic material. The communication network 235 may implement multiple communication protocols and security layers to ensure that sensitive data remains protected during transmission. In some cases, the communication network 235 may incorporate dedicated cryptographic channels, virtual private networks, or other secure communication mechanisms to prevent unauthorized interception of cryptographic operations and data.

An encryption device 240 within the communication system 200 performs message encryption operations using the secure attribute-based encryption protocol. The encryption device 240 contains an encryption processing unit 245 that executes the encryption algorithms, including trapdoor function computations, secret sharing operations, and ciphertext generation procedures. The encryption processing unit 245 may implement parallel processing capabilities to handle multiple encryption operations simultaneously, improving system throughput and responsiveness. A storage unit 250 associated with the encryption device 240 maintains encryption parameters, public keys, messages awaiting encryption, and generated ciphertext data. The storage unit 250 may implement temporary storage mechanisms that automatically purge sensitive data after encryption operations complete, reducing the exposure window for plaintext messages.

With continued reference to FIG. 2, a decryption device 255 operates within the communication system 200 to perform ciphertext decryption and message recovery operations. The decryption device 255 incorporates a decryption processing unit 260 that executes decryption algorithms, including share reconstruction procedures, trapdoor function inverse computations, and message recovery operations. The decryption processing unit 260 may implement secure computation environments that protect secret keys and intermediate decryption values from external observation during processing. A storage unit 265 within the decryption device 255 maintains secret keys, received ciphertext data, intermediate computation results, and recovered plaintext messages. In some cases, the storage unit 265 may implement access control mechanisms that restrict access to decrypted messages based on attribute-based policies and user authorization levels.

The distributed architecture of the communication system 200 enables separation of cryptographic functions across multiple processing units, reducing the risk of single points of failure and enhancing overall system security. The setup processing unit 210 focuses on parameter generation and system initialization, while the key generation processing unit 225 specializes in key management operations. The encryption processing unit 245 handles message encryption tasks, and the decryption processing unit 260 manages ciphertext decryption procedures. This functional separation allows each processing unit to be optimized for specific cryptographic operations while maintaining secure communication channels through the communication network 235.

The storage units 215, 230, 250, and 265 within the communication system 200 may implement different security levels and access controls based on the sensitivity of stored data. The storage unit 215 may provide read-only access to public parameters, while the storage unit 230 implements strict access controls for secret key material. The storage unit 250 may provide temporary storage for encryption operations, and the storage unit 265 may implement secure deletion mechanisms for decrypted messages. In some cases, the storage units may implement distributed storage mechanisms that replicate data across multiple physical locations to provide redundancy and availability for cryptographic operations.

### Encryption Parameter Generation

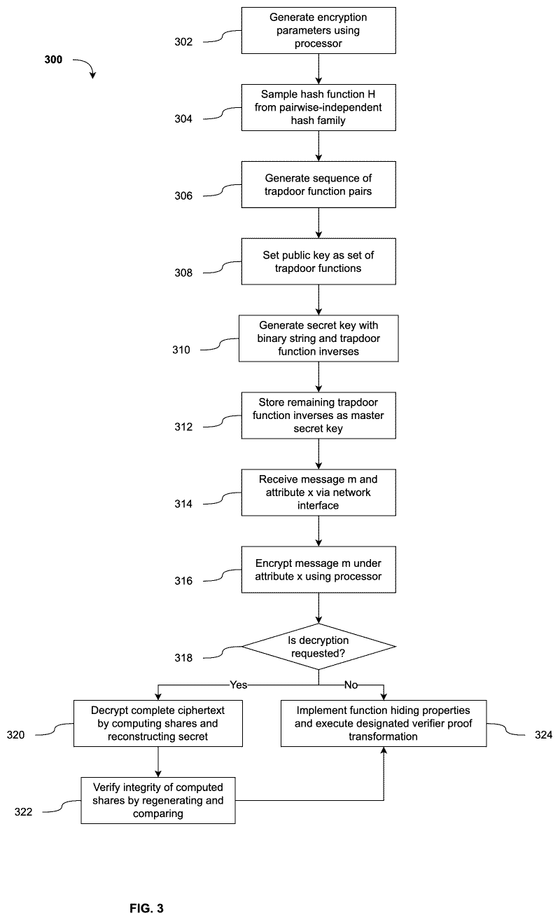

Referring to FIG. 3, a method 300 for secure attribute-based encryption with function hiding properties begins with generating encryption parameters using a processor. The method 300 commences at step 302 with the generation of encryption parameters that form the foundational cryptographic structure for the secure communication system. The parameter generation process involves multiple interconnected components that work together to establish the mathematical framework for both encryption operations and function hiding capabilities. In some cases, the encryption parameters may be generated using specialized cryptographic libraries that implement standardized algorithms for trapdoor function construction and hash function sampling.

At step 304, the method 300 samples a hash function H from a pairwise-independent hash family as a public parameter and stores the hash function H in a memory. The pairwise-independent hash family provides statistical properties that ensure the entropy of random secrets remains sufficiently high given the ciphertext components, thereby preventing statistical attacks against the encryption scheme. In some cases, the pairwise-independent hash family may be selected from constructions based on polynomial evaluation over finite fields, where the hash function H takes the form H (x)=ax+b mod p for randomly chosen coefficients a and b and a prime p. The selection of the hash function H from this family ensures that any two distinct inputs produce hash outputs that are statistically independent, which forms a cornerstone of the security analysis for the attribute-based encryption scheme.

The method 300 proceeds to step 306, where a sequence of trapdoor function pairs

$$( {g}_{i , b} , {g}_{i , b}^{- 1} )$$

for i∈[n]an b∈{0,1} are generated, where n is a positive integer, and the trapdoor function pairs are stored in the memory. The trapdoor function pairs

$$( {g}_{i , b} , {g}_{i , b}^{- 1} )$$

may be generated using a lossy trapdoor function setup algorithm that ensures the trapdoor functions can be sampled efficiently in either a lossy or injective mode. In the injective mode, the trapdoor function pairs

$$( {g}_{i , b} , {g}_{i , b}^{- 1} )$$

are efficiently computable and invertible with knowledge of the trapdoor, enabling legitimate decryption operations. The lossy mode provides computational security by making the trapdoor functions statistically lossy, meaning that multiple inputs may map to the same output, thereby hiding information about the encrypted data from unauthorized parties.

### Key Construction and Management

With continued reference to FIG. 3, the method 300 advances to step 308, where a public key pk is set as the set of trapdoor functions {g_{i,b}}_{i∈[n], b∈{0,1}}and stored in the memory. The public key pk construction creates a structured collection of trapdoor functions that correspond to different bit positions and binary values within the encryption scheme. In some cases, the public key pk may contain 2n distinct trapdoor functions, where each function g_{i,b} corresponds to the i-th position and binary value b. The organization of these functions within the public key pk enables the encryption process to select appropriate trapdoor functions based on the binary representation of attributes and secret sharing parameters.

At step 310, the method 300 generates a secret key sk comprising a binary string ƒ of length n and a set of trapdoor function inverses

$${\{ {g}_{i , {f}_{i}}^{- 1} \}}_{i ∈ [ n ]} ,$$

where ƒᵢ is the i-th bit of ƒ, and stores the secret key sk in the memory. The binary string ƒ serves as a selector that determines which trapdoor function inverses are included in the secret key sk for each position i. The construction of the secret key sk establishes a direct correspondence between the binary representation of authorized attributes and the cryptographic capabilities granted to the key holder. In some cases, the binary string ƒ may represent a specific access policy or attribute pattern that defines the decryption capabilities of the secret key sk.

The method 300 continues to step 312, where remaining trapdoor function inverses are stored as a master secret key in a memory. The master secret key contains the complete set of trapdoor function inverses

$${\{ {g}_{i , b}^{- 1} \}}_{i ∈ [ n ] , b ∈ \{ 0 , 1 \}}$$

that were not included in individual secret keys sk. This hierarchical key management structure enables the generation of multiple secret keys with different access patterns while maintaining a central authority that possesses complete decryption capabilities. The master secret key serves as the root of trust for the attribute-based encryption system and enables the generation of additional secret keys for new users or modified access policies.

### Attribute Processing and Function Relationships

As further shown in FIG. 3, the method 300 proceeds to step 314, where a message m and attribute x are received via a network interface device, and the message m and attribute a are stored in the memory. The attribute a and the binary string ƒ represent inputs to a function F(x, ƒ), where decryption succeeds if and only if F(x, ƒ)=1, thereby implementing attribute-based access control. The function F(x, ƒ) may implement various access control policies, including threshold schemes, boolean formulas, or more complex attribute relationships. In some cases, the function F(x, ƒ) may be designed to support non-monotone access structures, allowing for both positive and negative attribute requirements within the same policy.

The mathematical relationship between the attribute x, binary string ƒ, and access control function F(x, ƒ) establishes the foundation for secure attribute-based encryption. The attribute x may be encoded as a binary vector or processed through a deterministic mapping that produces binary values corresponding to specific attribute properties. The evaluation of F(x, ƒ) determines whether the holder of a secret key sk with binary string ƒ can successfully decrypt a ciphertext encrypted under attribute x. This relationship enables fine-grained access control where decryption capabilities are tied to specific attribute patterns rather than simple key possession.

The method 300 advances to step 316, where the message m is encrypted under the attribute a using the processor. The encryption process utilizes the previously generated encryption parameters, including the hash function H, trapdoor functions from the public key pk, and the attribute a to produce a ciphertext that can be decrypted by authorized secret keys. The encryption operation creates a mathematical binding between the message m and the attribute a through the use of secret sharing schemes and trapdoor function evaluations. In some cases, the encryption process may implement a secret sharing scheme for non-monotone functions, allowing reconstruction of encryption secrets from authorized subsets of shares while preventing reconstruction from unauthorized combinations.

### Message Encryption Process

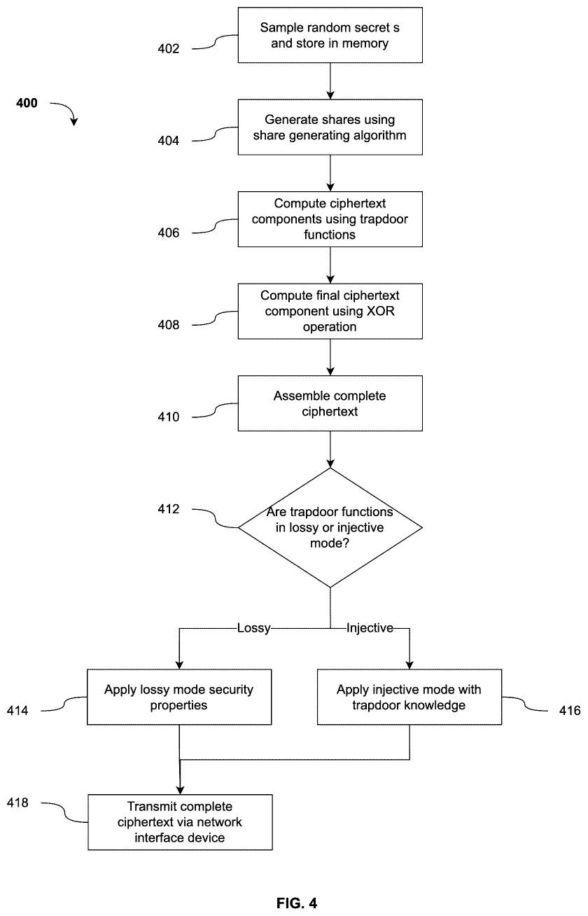

Referring to FIG. 4, a method 400 illustrates the encryption process for secure attribute-based encryption with function hiding properties. The method 400 begins at step 402, where a random secret s is sampled and stored in memory. The sampling of the random secret s forms the foundation for the subsequent cryptographic operations, as the random secret s provides the entropy source for the share generation algorithm. In some cases, the random secret s may be generated using a cryptographically secure pseudorandom number generator that ensures sufficient entropy for the security properties of the encryption scheme. The storage of the random secret s in memory enables subsequent processing steps to access the random secret s for share generation and ciphertext component computation.

The method 400 proceeds to step 404, where shares are generated using a share generating algorithm. The share generating algorithm produces shares (a_{1,0}, a_{1,1}, . . . , a_{n,0}, a_{n,1}) that correspond to the secret sharing scheme implementation. The share generating algorithm may implement a secret sharing scheme for non-monotone functions, allowing reconstruction of the secret s from an authorized subset of the shares. In some cases, the share generating algorithm distributes the random secret s across multiple shares such that the secret s can be reconstructed when a sufficient number of authorized shares are available. The generated shares are stored in memory to facilitate the subsequent ciphertext component computation process.

As shown in FIG. 4, the method 400 continues to step 406, where ciphertext components are computed using trapdoor functions. The computation involves applying trapdoor functions g_{i,b} to the corresponding shares die to produce ciphertext components ct_{i,b}=g_{i,b}(a_{i,b}) for i∈[n] and b∈{0, 1}. The trapdoor functions may be generated using a lossy trapdoor function setup algorithm that ensures the trapdoor functions can be sampled efficiently in either a lossy or injective mode. The ciphertext components are stored in memory as intermediate results that contribute to the complete ciphertext assembly. In some cases, the trapdoor functions are efficiently computable and invertible in the injective mode with knowledge of the trapdoor, enabling authorized decryption operations.

The method 400 proceeds to step 408, where a final ciphertext component is computed using an XOR operation. The final ciphertext component ct₀ is computed as ct₀=m⊕H(s), where ⊕ denotes bitwise XOR, m represents the message to be encrypted, and H(s) represents the hash function applied to the random secret s. The hash function H may be sampled from a pairwise-independent hash family to ensure that the entropy of the random secret s given the ciphertext components is sufficiently high to prevent statistical attacks. The final ciphertext component ct₀ is stored in memory alongside the other ciphertext components to enable complete ciphertext assembly.

With continued reference to FIG. 4, the method 400 moves to step 410, where a complete ciphertext is assembled. The complete ciphertext is structured as (ct₀, {ct_{i,b}}_{i∈[n],b∈{0,1}}), combining the final ciphertext component ct₀ with the collection of ciphertext components ct_{i,b}. The assembly process organizes the ciphertext components in a format that enables efficient transmission and subsequent decryption operations. The complete ciphertext is stored in a storage device to maintain data integrity and enable retrieval for transmission or further processing operations.

The method 400 includes step 412, which presents a decision point determining whether trapdoor functions are in lossy or injective mode. This decision logic enables the encryption process to adapt to different security models and operational requirements. When the trapdoor functions operate in lossy mode, the method 400 proceeds to step 414, where lossy mode security properties are applied. In lossy mode, the trapdoor functions may lose information about their inputs, providing computational security based on the difficulty of inverting the lossy functions without knowledge of the trapdoor. Alternatively, when the trapdoor functions operate in injective mode, the method 400 proceeds to step 416, where injective mode with trapdoor knowledge is applied. In injective mode, the trapdoor functions maintain a one-to-one mapping that can be efficiently inverted with knowledge of the trapdoor.

As further shown in FIG. 4, both the lossy mode path from step 414 and the injective mode path from step 416 converge at step 418, where the complete ciphertext is transmitted via a network interface device. The transmission process may involve formatting the complete ciphertext for network protocols and ensuring data integrity during transmission. In some cases, the transmission may include additional metadata or authentication information to support designated verifier capabilities. The network interface device facilitates communication with remote systems that may perform decryption operations or further processing of the complete ciphertext.

The decision logic for handling lossy versus injective trapdoor function modes provides flexibility in the encryption scheme's security model. In lossy mode, the security properties rely on the computational difficulty of inverting lossy trapdoor functions, while in injective mode, the security properties depend on the secrecy of the trapdoor information. The method 400 maintains security properties in both operational modes while enabling designated verifier capabilities through the structured ciphertext format and the underlying cryptographic primitives. The complete ciphertext assembly and transmission process preserves the function hiding properties of the encryption scheme, ensuring that adversaries cannot distinguish between different implementations of encryption functions that produce the same input-output behavior.

### Message Decryption and Recovery

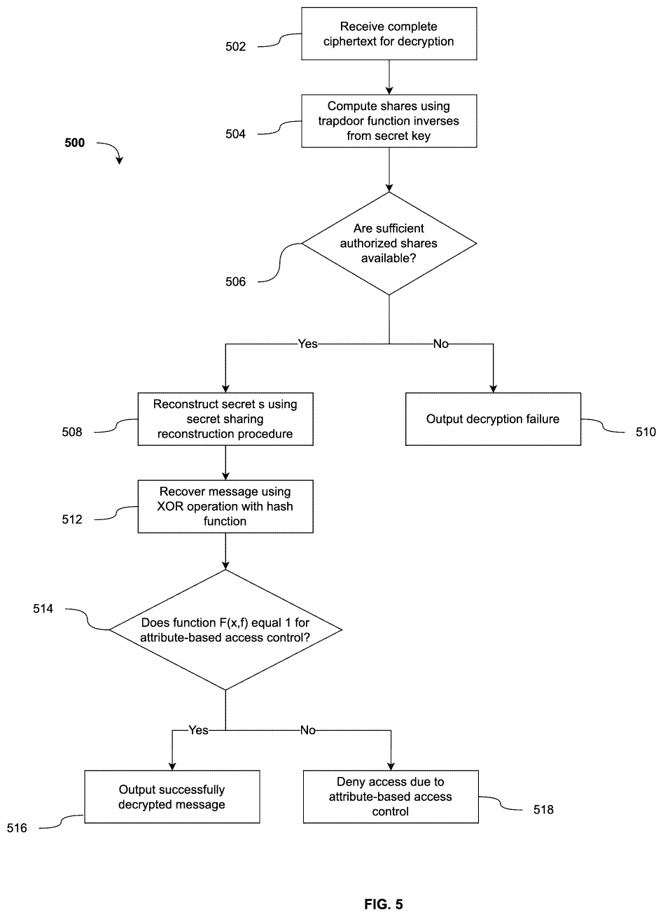

Referring to FIG. 5, a method 500 illustrates the decryption process for recovering messages from the complete ciphertext generated during the encryption phase. The method 500 begins at a step 502, where the decryption module 720 receives the complete ciphertext for processing. The complete ciphertext comprises the final ciphertext component ct₀ and the collection of ciphertext components {ct_{i,b}}_{i∈[n],b∈{0,1}} that were generated during the encryption process. The decryption processing unit 260 initiates the decryption sequence by accessing the secret key sk stored in storage unit 265, which contains the binary string ƒ of length n and the corresponding set of trapdoor function inverses

$${\{ {g}_{i , {f}_{i}}^{- 1} \}}_{i ∈ [ n ]} .$$

The share reconstruction engine 722 prepares to execute the computational procedures for recovering the underlying secret and subsequently the original message.

The method 500 proceeds to a step 504, where the decryption processing unit 260 computes shares using the trapdoor function inverses from the secret key. The computation follows the mathematical relationship

$${a}_{i , {f}_{i}} = {g}_{i , {f}_{i}}^{- 1} ( {ct}_{i , {f}_{i}} )$$

for each trapdoor function inverse

$${g}_{i , {f}_{i}}^{- 1} ∈ sk .$$

This computation leverages the invertible property of the trapdoor functions in injective mode, where the trapdoor function inverses can efficiently reverse the operations performed during encryption. The share reconstruction engine 722 applies the trapdoor function inverses to the corresponding ciphertext components, extracting the shares that were originally generated during the encryption process. The computed shares represent partial information about the random secret s that was used to encrypt the message, and these shares are stored in memory subsystem 2035 for subsequent processing.

With continued reference to FIG. 5, the method 500 advances to a step 506, which presents a decision point for determining whether sufficient authorized shares are available for secret reconstruction. The share reconstruction engine 722 evaluates the computed shares against the access structure defined by the secret sharing scheme for non-monotone functions. The decision logic examines whether the subset of recovered shares satisfies the authorization conditions encoded in the share generating algorithm. In cases where the attribute x and the binary string ƒ represent inputs to a function F(x, ƒ), the system evaluates whether the recovered shares correspond to an authorized combination that enables secret reconstruction. The integrity verification unit 724 may perform preliminary checks on the computed shares to ensure their validity before proceeding with the reconstruction procedure.

If sufficient authorized shares are not available, the method 500 proceeds to a step 510, where the decryption processing unit 260 outputs a decryption failure. This failure condition occurs when the secret key sk does not contain the appropriate trapdoor function inverses corresponding to the attribute a used during encryption, or when the access control policy prevents the current user from accessing the encrypted message. The message recovery unit 726 generates an error indication that is stored in storage unit 265 and may be transmitted via network interface 736 to notify the requesting entity of the unsuccessful decryption attempt. The failure mechanism provides a security barrier that prevents unauthorized access to encrypted messages while maintaining the integrity of the cryptographic system.

When sufficient authorized shares are available, the method 500 continues to a step 508, where the share reconstruction engine 722 reconstructs the secret s using a secret sharing reconstruction procedure on the computed shares. The reconstruction procedure implements mathematical algorithms that combine the authorized shares to recover the original random secret that was used during encryption. The secret sharing reconstruction procedure may employ techniques such as Lagrange interpolation for polynomial-based secret sharing schemes or linear algebraic methods for linear secret sharing schemes. The reconstructed secret s is temporarily stored in system memory 2040 with appropriate security measures to prevent unauthorized access during the brief period required for message recovery.

As further shown in FIG. 5, the method 500 proceeds to a step 512, where the message recovery unit 726 recovers the message using the reconstructed secret. The recovery process implements the mathematical relationship m=ct₀⊕H(s), where the final ciphertext component ct₀ is combined with the hash of the reconstructed secret using the bitwise XOR operation. The hash function H from the pairwise-independent hash family is applied to the reconstructed secret s to generate the same pseudorandom mask that was used during encryption. The XOR operation between ct₀ and H(s) effectively removes the cryptographic mask, revealing the original message m. The central processing unit 2010 executes these computations efficiently, leveraging cache memory 2020 to optimize performance during the hash function evaluation and XOR operations.

The method 500 advances to a step 514, which implements attribute-based access control through function evaluation. The decryption processing unit 260 evaluates whether the function F(x, ƒ)=1, where a represents the attribute used during encryption and f represents the binary string from the secret key. This evaluation determines whether the current secret key holder is authorized to access the message encrypted under the specific attribute x. The function F(x, ƒ) encodes the access control policy that was established during the system setup phase, and the evaluation result determines whether decryption should succeed or fail based on the attribute-based access control mechanism.

If the function evaluation F(x, ƒ)=1 indicates authorized access, the method 500 proceeds to a step 516, where the decryption processing unit 260 outputs the successfully decrypted message. The recovered message m is made available to the requesting application or user through the client I/O subsystem 2070, which may include display interface 2085 for presenting the message content or network interface controller 2080 for transmitting the message to other systems. The successful decryption completion is logged in storage subsystem 2050 for audit purposes, and the temporary cryptographic materials such as the reconstructed secret s are securely erased from memory to prevent potential security vulnerabilities.

Alternatively, if the function evaluation F(x, ƒ)≠ 1 indicates unauthorized access, the method 500 proceeds to a step 518, where the system denies access due to attribute-based access control restrictions. The message recovery unit 726 generates an access denial notification that is stored in non-volatile memory 2045 and may be transmitted to the requesting entity. This denial mechanism ensures that even if the decryption process successfully reconstructs the secret and recovers the message content, the final access control check prevents unauthorized disclosure of the message. The attribute-based access control provides an additional security layer that operates independently of the cryptographic decryption process, enabling fine-grained access control policies.

The integrity verification procedures within the method 500 provide additional security mechanisms that prevent unauthorized decryption while maintaining the integrity of the cryptographic system. The integrity verification unit 724 may regenerate shares using the reconstructed secret s and apply the trapdoor functions g_{i,b} to the regenerated shares. The results are compared with the original ciphertext components ct_{i,b} to verify that the decryption process has proceeded correctly and that no tampering or corruption has occurred. This verification process ensures that the reconstructed secret is authentic and that the recovered message represents the original plaintext that was encrypted. The verification mechanisms operate in conjunction with the designated verifier proof system to provide comprehensive security assurance throughout the decryption process.

### Designated Verifier Proof Construction

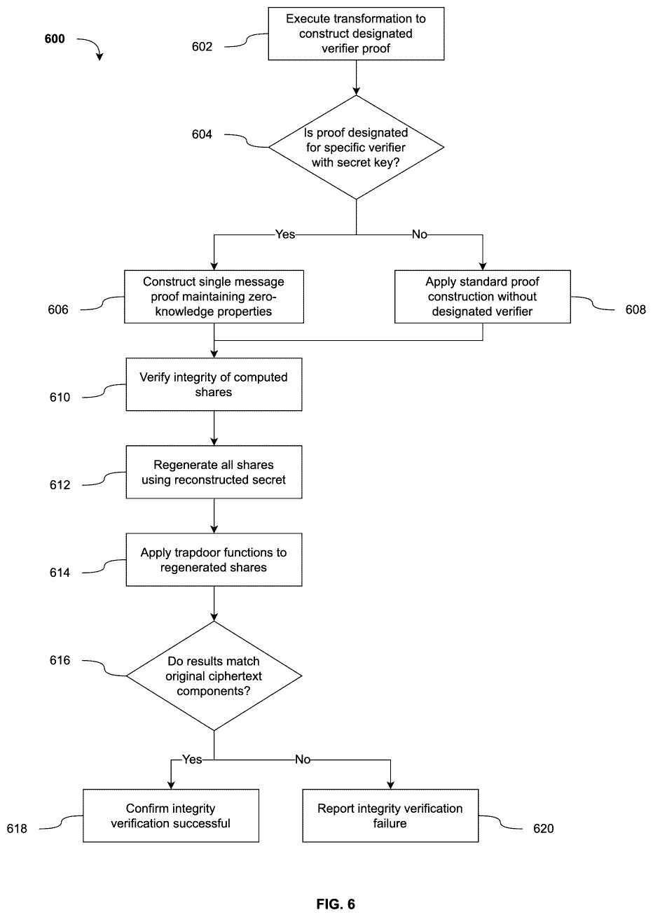

Referring to FIG. 6, a method 600 illustrates the process of executing and verifying designated verifier proofs within the secure attribute-based encryption system. The method 600 begins at step 602 with executing a transformation to construct a designated verifier proof. This transformation process converts the standard attribute-based encryption scheme into a designated verifier non-interactive zero knowledge proof system, where the proof is designated for a specific verifier with a secret verification key. The transformation ensures that the resulting proof preserves the security properties of the original attribute-based encryption scheme while adding the designated verifier property. In some cases, the transformation may involve modifying the ciphertext structure to incorporate additional cryptographic elements that enable the designated verifier functionality while maintaining the underlying security guarantees of the attribute-based encryption protocol.

The method 600 then proceeds to step 604, which presents a decision point determining whether the proof is designated for a specific verifier with a secret verification key. This decision point evaluates the configuration parameters of the proof system to determine the appropriate construction path. When the proof is designated for a specific verifier (Yes branch), the method 600 moves to step 606, where the system constructs a single message proof maintaining zero-knowledge properties. The proof consists of a single message from the prover to the designated verifier, eliminating the need for multiple rounds of communication between the parties. This single-message construction enables efficient proof transmission while preserving the zero-knowledge characteristics that prevent information leakage about the underlying witness or secret values.

In cases where the proof is not designated for a specific verifier (No branch), the method 600 proceeds to step 608, where the system applies standard proof construction without designated verifier properties. This alternative path maintains compatibility with conventional proof systems while providing a fallback mechanism for scenarios where designated verifier functionality is not required. The standard proof construction may utilize traditional zero-knowledge proof techniques that do not incorporate the specialized designated verifier properties but still provide cryptographic soundness and completeness guarantees.

### Integrity Verification Process

From step 606, the method 600 continues to step 610, where the system verifies the integrity of computed shares. This verification process forms a fundamental component of the designated verifier proof system, ensuring that the cryptographic operations have been performed correctly and that no malicious modifications have occurred during the proof construction or transmission phases. The integrity verification process begins by examining the shares that were computed during the decryption process, validating their mathematical consistency with the expected cryptographic relationships. As shown in FIG. 6, the verification process incorporates multiple stages of validation to provide comprehensive security assurance against various attack vectors.

The method 600 then moves to step 612, where the system regenerates shares using the reconstructed secret s. This regeneration process involves applying the same share generating algorithm that was used during the original encryption process, utilizing the reconstructed secret s as input to produce a new set of shares. The regeneration process serves as a cryptographic consistency check, enabling the system to verify that the reconstructed secret s is mathematically consistent with the original ciphertext components. In some cases, the share regeneration may involve complex mathematical operations that mirror the original encryption process, ensuring that the verification process maintains the same level of cryptographic rigor as the original encryption and decryption operations.

At step 614, the method 600 applies trapdoor functions g_{i,b} to the regenerated shares. This application process involves computing the trapdoor function outputs for the regenerated shares, producing values that can be directly compared with the original ciphertext components. The trapdoor function application utilizes the same function parameters and configurations that were employed during the original encryption process, ensuring mathematical consistency between the verification process and the original cryptographic operations. The application of trapdoor functions to regenerated shares provides a mechanism for detecting any inconsistencies or errors that may have occurred during the decryption or reconstruction processes.

### Verification Result Processing

The method 600 then proceeds to step 616, which presents another decision point determining whether the results match the original ciphertext components ct_{i,b}. This comparison process involves performing mathematical equality checks between the computed trapdoor function outputs and the corresponding ciphertext components that were included in the original encrypted message. The comparison process may utilize various mathematical techniques to ensure accurate detection of any discrepancies, including bitwise comparisons, hash-based verification, or other cryptographic validation methods. When the results match the original ciphertext components (Yes branch), the method 600 moves to step 618, where the system confirms that integrity verification has been successful.

In cases where the results do not match the original ciphertext components (No branch), the method 600 proceeds to step 620, where the system reports integrity verification failure. This failure indication serves as a security mechanism that prevents the acceptance of potentially corrupted or maliciously modified cryptographic data. The failure reporting process may involve generating error messages, logging security events, or triggering additional security protocols to address the detected integrity violation. The integrity verification failure may indicate various types of attacks or errors, including man-in-the-middle attacks, data corruption during transmission, or computational errors during the cryptographic operations.

### Zero-Knowledge Properties and Security Guarantees

The designated verifier proof construction maintains several fundamental security properties that distinguish the system from conventional proof mechanisms. The proof demonstrates knowledge of a witness for a statement without revealing any information about the witness beyond its existence, preserving the zero-knowledge characteristics that are fundamental to secure cryptographic protocols. This property ensures that the designated verifier can validate the correctness of the proof without gaining access to sensitive information about the underlying message, attributes, or cryptographic secrets. In some cases, the zero-knowledge properties may be maintained through sophisticated mathematical techniques that carefully balance the information disclosure necessary for verification with the privacy requirements of the underlying cryptographic system.

The designated verifier proof system incorporates additional security guarantees that enhance the overall security posture of the attribute-based encryption scheme. The proof cannot be re-used or transferred to convince any other party of the statement's validity, preventing replay attacks and unauthorized proof sharing. This non-transferability property ensures that the proof remains bound to the specific designated verifier and cannot be leveraged by malicious parties to gain unauthorized access or to impersonate legitimate verifiers. Furthermore, the designated verifier cannot use the proof to convince others, maintaining zero-knowledge even if the verifier is malicious. This property protects against scenarios where the designated verifier may attempt to leverage the proof information for unauthorized purposes or to compromise the privacy of the original prover. The integrity verification process provides comprehensive protection against various attack vectors that may target the designated verifier proof system. By regenerating shares using the reconstructed secret s and applying trapdoor functions g_{i,b} to the regenerated shares, the system can detect modifications, corruptions, or inconsistencies that may have been introduced during the proof construction, transmission, or verification processes. The comparison with original ciphertext components ctit provides a final validation step that ensures the mathematical consistency of the entire cryptographic operation, from initial encryption through final verification.

### Secure Encryption System Implementation

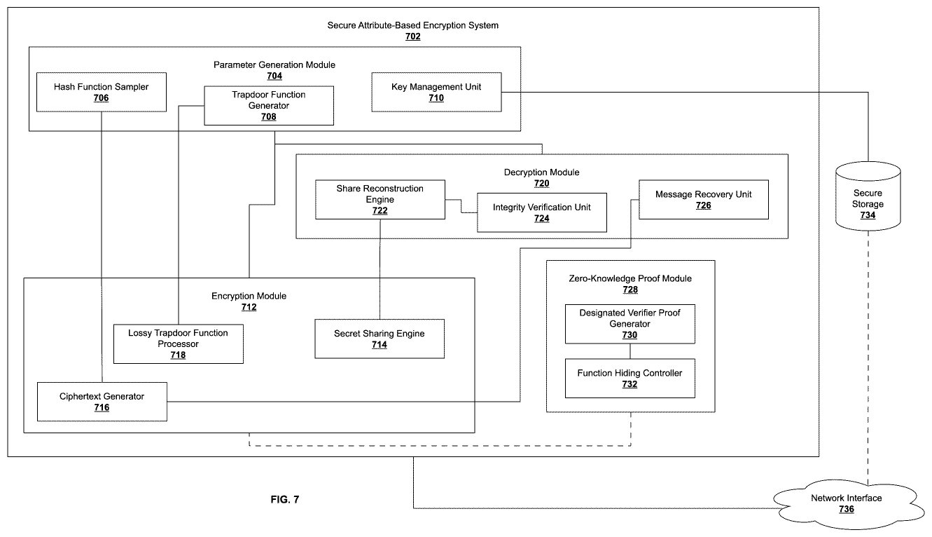

Referring to FIG. 7, a secure attribute-based encryption system 702 provides a comprehensive cryptographic architecture that implements function hiding properties and designated verifier proof capabilities. The secure attribute-based encryption system 702 comprises multiple interconnected modules that work together to perform encryption, decryption, and verification operations while maintaining security properties against various attack vectors. The system architecture enables secure communication between parties while preserving the confidentiality of both the encrypted data and the underlying encryption functions used in the process. The modular design of the secure attribute-based encryption system 702 allows for scalable deployment across different network environments and supports various cryptographic protocols.

A parameter generation module 704 forms the foundation of the secure attribute-based encryption system 702 and handles the initialization of cryptographic parameters used throughout the encryption and decryption processes. The parameter generation module 704 contains specialized components that generate the mathematical structures underlying the attribute-based encryption scheme. Within the parameter generation module 704, a hash function sampler 706 samples hash functions from pairwise-independent hash families, where the selected hash function H serves as a public parameter for the encryption scheme. The hash function sampler 706 ensures that the entropy of a random secret s given ciphertext components remains sufficiently high to prevent statistical attacks, thereby maintaining the security properties of the overall system. The pairwise-independent hash family selection performed by the hash function sampler 706 provides collision resistance and uniform distribution properties that are utilized during the encryption and decryption operations.

A trapdoor function generator 708 operates within the parameter generation module 704 to create the trapdoor function pairs

$$( {g}_{i , b} , {g}_{i , b}^{- 1} )$$

for i∈[n] and b∈{0,1}, where n represents a positive integer parameter. The trapdoor function generator 708 implements a lossy trapdoor function setup algorithm that ensures the trapdoor functions can be sampled efficiently in either a lossy or injective mode, providing flexibility in the security model. In the injective mode, the trapdoor function pairs

$$( {g}_{i , b} , {g}_{i , b}^{- 1} )$$

are efficiently computable and invertible with knowledge of the trapdoor, enabling authorized parties to perform decryption operations. The trapdoor function generator 708 creates these mathematical structures such that they maintain their security properties under both computational and statistical security models, supporting the dual-mode operation that enables security proofs under different assumptions.

A key management unit 710 connects to the parameter generation module 704 and manages the distribution and storage of cryptographic keys generated by the system. The key management unit 710 handles the creation of public keys pk as sets of trapdoor functions {g_{i,b}}_{i∈[n],b∈{0,1}} and manages secret keys sk comprising binary strings ƒ of length n and sets of trapdoor function inverses

$${\{ {g}_{i , {f}_{i}}^{- 1} \}}_{i ∈ [ n ]} ,$$

where ƒᵢ represents the i-th bit of ƒ. The key management unit 710 also stores remaining trapdoor function inverses as master secret keys, maintaining the hierarchical key structure that enables attribute-based access control. The key management unit 710 implements secure key derivation procedures that ensure the independence of individual user keys while maintaining the ability to perform attribute-based encryption and decryption operations.

An encryption module 712 receives input messages and attributes from external sources and performs the encryption operations using the parameters and keys managed by the parameter generation module 704 and key management unit 710. The encryption module 712 implements the core encryption algorithm that transforms plaintext messages into ciphertext under specified attributes, ensuring that decryption can occur when the appropriate attribute-based conditions are satisfied. Within the encryption module 712, a secret sharing engine 714 generates shares (a_{1,0}, a_{1,1}, . . . , a_{n,0}, a_{n,1}) using a share generating algorithm that implements a secret sharing scheme for non-monotone functions. The secret sharing engine 714 enables reconstruction of the secret s from an authorized subset of the shares, supporting complex access policies that go beyond simple threshold schemes. The share generating algorithm implemented by the secret sharing engine 714 distributes the random secret s across multiple shares in a manner that preserves the security properties while enabling efficient reconstruction when authorized attributes are present.

A ciphertext generator 716 operates within the encryption module 712 to compute ciphertext components ct_{i,b}=g_{i,b}(a_{i,b}) for i∈[n] and b∈{0, 1} using the trapdoor functions generated by the trapdoor function generator 708. The ciphertext generator 716 also computes a final ciphertext component ct₀=m⊕H(s), where ⊕ denotes bitwise XOR operation and m represents the input message. The ciphertext generator 716 assembles these components into a complete ciphertext structure (ct₀, {ct_{i,b}}_{i∈[n],b∈{0,1}}) that can be transmitted over networks while maintaining the confidentiality of the underlying message. The ciphertext generation process performed by the ciphertext generator 716 ensures that the resulting ciphertext maintains the function hiding properties, where an adversary with access to the complete ciphertext and the message cannot distinguish between two different implementations of encryption functions that produce the same input-output behavior.

A lossy trapdoor function processor 718 within the encryption module 712 manages the dual-mode operation of the trapdoor functions, handling both lossy and injective modes depending on the security requirements and operational context. The lossy trapdoor function processor 718 ensures that the encryption process maintains its security properties regardless of which mode the trapdoor functions operate in, providing flexibility in the security model while maintaining consistent functionality. The lossy trapdoor function processor 718 coordinates with the trapdoor function generator 708 to ensure that the mode selection aligns with the overall security parameters of the system and the specific requirements of the encryption operation being performed.

A decryption module 720 receives encrypted ciphertext and performs the decryption operations using the secret keys managed by the key management unit 710. The decryption module 720 implements the inverse operations of the encryption module 712, recovering the original message when the appropriate attribute-based conditions are satisfied. Within the decryption module 720, a share reconstruction engine 722 computes shares

$${a}_{i , {f}_{i}} = {g}_{i , {f}_{i}}^{- 1} ( {ct}_{i , {f}_{i}} )$$

for trapdoor function inverses

$${g}_{i , {f}_{i}}^{- 1} ∈ sk$$

and reconstructs the secret s using a secret sharing reconstruction procedure on the computed shares. The share reconstruction engine 722 implements algorithms that can handle non-monotone access structures, enabling complex attribute-based policies while maintaining efficient reconstruction procedures. The reconstruction process performed by the share reconstruction engine 722 verifies that the attribute a and the binary string ƒ represent inputs to a function F(x, ƒ), where decryption succeeds when F(x, ƒ)=1, thereby implementing attribute-based access control.

An integrity verification unit 724 operates within the decryption module 720 to verify the integrity of computed shares during the decryption process. The integrity verification unit 724 regenerates shares using the reconstructed secret s, applies the trapdoor functions gib to the regenerated shares, and compares the results with the original ciphertext components ct_{i,b}. This verification process ensures that the decryption operation has been performed correctly and that the reconstructed secret corresponds to the original secret used during encryption. The integrity verification unit 724 provides protection against various attack scenarios where adversaries might attempt to manipulate ciphertext components or inject false shares into the reconstruction process.

A message recovery unit 726 within the decryption module 720 performs the final step of the decryption process by recovering the original message as m=ct₀⊕H(s) using the reconstructed secret s and the hash function H. The message recovery unit 726 ensures that the recovered message maintains its original format and content, completing the decryption process when the attribute-based access control conditions are satisfied. The message recovery unit 726 coordinates with the integrity verification unit 724 to ensure that message recovery occurs when the verification procedures confirm the validity of the decryption operation.

A zero-knowledge proof module 728 connects to the decryption module 720 and implements advanced cryptographic protocols that enable verification of decryption operations without revealing sensitive information. The zero-knowledge proof module 728 executes transformations to construct designated verifier non-interactive zero-knowledge proofs that demonstrate knowledge of witnesses for statements without revealing information about the witnesses beyond their existence. Within the zero-knowledge proof module 728, a designated verifier proof generator 730 creates proofs that are designated for specific verifiers with secret verification keys, ensuring that the proofs consist of single messages from provers to designated verifiers. The designated verifier proof generator 730 ensures that designated verifiers possessing secret verification keys can validate the proofs, while the proofs cannot be re-used or transferred to convince other parties of the statements' validity. The designated verifier cannot use the proof to convince others, maintaining zero-knowledge properties even when the verifier may be malicious.

A function hiding controller 732 operates within the zero-knowledge proof module 728 to implement function hiding properties throughout the cryptographic operations. The function hiding controller 732 ensures that transformations preserve the security properties of the original attribute-based encryption scheme while adding the designated verifier property. The function hiding controller 732 coordinates with other system components to maintain the indistinguishability of different encryption function implementations that produce the same input-output behavior, providing protection against adversaries who might attempt to learn information about the underlying encryption functions through observation of ciphertext and message pairs.

A secure storage 734 connects to the secure attribute-based encryption system 702 and provides persistent storage for encryption parameters, cryptographic keys, and other sensitive data used throughout the system operations. The secure storage 734 implements access controls and encryption mechanisms to protect stored data from unauthorized access while enabling efficient retrieval by authorized system components. The secure storage 734 maintains the integrity and confidentiality of stored cryptographic materials, supporting the long-term security of the attribute-based encryption system. A network interface 736 enables communication between the secure attribute-based encryption system 702 and external networks and devices, facilitating the transmission of encrypted data and the coordination of cryptographic operations across distributed environments. The network interface 736 implements secure communication protocols that protect data in transit while enabling the system to operate effectively in networked environments where multiple parties may participate in encryption and decryption operations.

### Client Computing Architecture

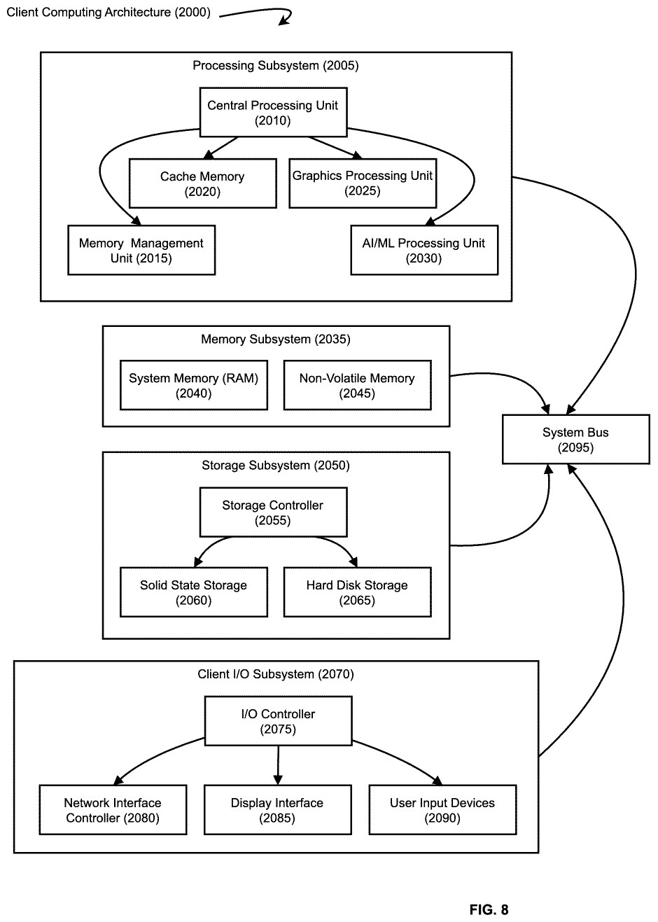

Referring to FIG. 8, a client computing architecture 2000 provides the computational infrastructure for executing secure attribute-based encryption operations and managing cryptographic data processing tasks. The client computing architecture 2000 comprises multiple interconnected subsystems that work together to support the complex mathematical operations involved in the encryption and decryption processes described herein. The architecture may be configured to handle the intensive computational demands of trapdoor function operations, secret sharing algorithms, and hash function computations that form the foundation of the secure attribute-based encryption system. In some cases, the client computing architecture 2000 may be implemented as a standalone computing device, a mobile device, or as part of a distributed computing environment where cryptographic operations are performed locally while maintaining secure communication with remote systems.

The client computing architecture 2000 includes a processing subsystem 2005 that serves as the computational engine for executing the various cryptographic algorithms and mathematical operations. The processing subsystem 2005 comprises a central processing unit 2010 that handles the primary computational tasks, including the generation of trapdoor function pairs

$$( {g}_{i , b} , {g}_{i , b}^{- 1} )$$

for i∈[n] and b∈{0,1} sing a lossy trapdoor function setup algorithm. The central processing unit 2010 may be configured to efficiently sample these trapdoor functions in either a lossy or injective mode, depending on the security requirements of the specific encryption operation being performed. The processing subsystem 2005 also includes a memory management unit 2015 that coordinates data flow between the various memory components and ensures efficient allocation of memory resources during cryptographic operations. A cache memory 2020 provides high-speed temporary storage for frequently accessed cryptographic parameters, intermediate computation results, and cached trapdoor function values to accelerate the encryption and decryption processes.

With continued reference to FIG. 8, the processing subsystem 2005 incorporates a graphics processing unit 2025 that may be utilized for parallel processing of cryptographic operations, particularly when dealing with large-scale secret sharing computations or when processing multiple ciphertext components simultaneously. The graphics processing unit 2025 may be configured to handle the parallel computation of ciphertext components ct_{i,b}=g_{i,b}(a_{i,b}) for multiple values of i∈[n] and b∈{0, 1}, thereby accelerating the encryption process through parallel execution. An AI processing unit 2030 may be integrated within the processing subsystem 2005 to optimize cryptographic operations through machine learning algorithms, pattern recognition for security threat detection, or adaptive optimization of encryption parameters based on usage patterns and security requirements. The AI processing unit 2030 may also assist in the implementation of function hiding properties by analyzing encryption patterns and ensuring that adversaries cannot distinguish between different implementations of encryption functions that produce the same input-output behavior.

The client computing architecture 2000 includes a memory subsystem 2035 that provides various types of memory storage for cryptographic data, encryption parameters, and intermediate computation results. The memory subsystem 2035 comprises system memory 2040, which may be implemented as random access memory (RAM) that stores active cryptographic operations, including the hash function H sampled from a pairwise-independent hash family, the public key pk comprising the set of trapdoor functions {g_{i,b}}_{i∈[n],b∈{0,1}}, and the secret key sk containing the binary string ƒ of length n and the corresponding trapdoor function inverses. The system memory 2040 may also store the shares (a_{1,0}, a_{1,1}, . . . , a_{n,0}, a_{n,1}) generated by the share generating algorithm that implements a secret sharing scheme for non-monotone functions, allowing reconstruction of the secret s from an authorized subset of the shares. Non-volatile memory 2045 provides persistent storage for long-term cryptographic parameters, master secret keys, and configuration data that must be retained across system power cycles and reboots.

As further shown in FIG. 8, the client computing architecture 2000 incorporates a storage subsystem 2050 that manages long-term data storage and retrieval operations for cryptographic data and system operations. The storage subsystem 2050 includes a storage controller 2055 that coordinates data access operations and manages the interface between the processing subsystem 2005 and the various storage devices. Solid state storage 2060 provides high-speed, non-volatile storage for frequently accessed cryptographic parameters, cached encryption keys, and intermediate computation results that may be needed for subsequent cryptographic operations. The solid state storage 2060 may be configured with hardware-level encryption capabilities to provide additional security for stored cryptographic data. Hard disk storage 2065 offers high-capacity storage for archived cryptographic data, historical encryption logs, and backup copies of cryptographic keys and parameters. The combination of solid state storage 2060 and hard disk storage 2065 provides a tiered storage architecture that balances performance requirements with storage capacity needs for comprehensive cryptographic data management.

The client computing architecture 2000 includes a client I/O subsystem 2070 that manages input and output operations for the secure attribute-based encryption system. The client I/O subsystem 2070 comprises an I/O controller 2075 that coordinates data flow between the internal system components and external interfaces. A network interface controller 2080 enables secure communication with remote systems, allowing the transmission of complete ciphertexts (ct₀, {ct_{i,b}}_{i∈[n],b∈{0,1}}) and the reception of messages in and attributes a for encryption operations. The network interface controller 2080 may implement additional security protocols to protect cryptographic data during transmission and ensure the integrity of received data. A display interface 2085 provides visual output capabilities for system status information, encryption operation progress, and user interface elements related to cryptographic operations. User input devices 2090 enable user interaction with the secure attribute-based encryption system, allowing users to initiate encryption operations, specify attributes for access control, and configure system parameters.

The various subsystems within the client computing architecture 2000 are interconnected through a system bus 2095 that facilitates high-speed data transfer and communication between components. The system bus 2095 may be implemented as a high-bandwidth interconnect that supports the intensive data transfer requirements of cryptographic operations, including the movement of large cryptographic parameters, intermediate computation results, and ciphertext data between the processing subsystem 2005, memory subsystem 2035, storage subsystem 2050, and client I/O subsystem 2070. The system bus 2095 may incorporate security features such as data encryption and access control mechanisms to protect sensitive cryptographic data during internal system transfers. In some cases, the system bus 2095 may support multiple concurrent data transfer operations to enable parallel processing of cryptographic operations across different subsystems.

The client computing architecture 2000 may be configured to support attribute-based access control operations where the attribute a and the binary string ƒ represent inputs to a function F(x, ƒ), and decryption succeeds if and only if F(x, ƒ)=1. The processing subsystem 2005 may evaluate this function using the central processing unit 2010 or distribute the computation across multiple processing units for enhanced performance. The trapdoor function pairs

$$( {g}_{i , b} , {g}_{i , b}^{- 1} )$$

may be efficiently computable and invertible in the injective mode with knowledge of the trapdoor, enabling the system to perform both encryption and decryption operations with optimal computational efficiency. The memory subsystem 2035 may store precomputed values and lookup tables to accelerate the evaluation of trapdoor functions and reduce the computational overhead associated with cryptographic operations.

### Network Architecture and Cloud Services Integration

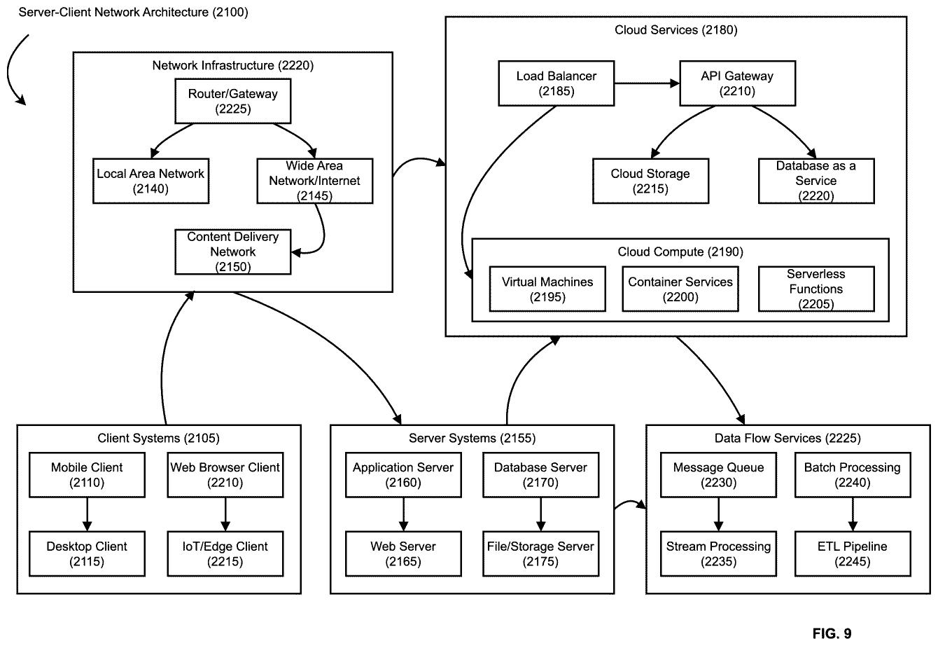

Referring to FIG. 9, a network architecture 2100 provides a comprehensive distributed computing environment for deploying the secure attribute-based encryption system across multiple computing platforms and service layers. The network architecture 2100 encompasses client systems 2105, server systems 2155, and cloud services 2180, interconnected through network infrastructure 2220 to enable scalable cryptographic operations. The distributed nature of the network architecture 2100 allows for the deployment of encryption parameters, trapdoor function generation, and ciphertext processing across geographically dispersed computing resources while maintaining the security properties of the attribute-based encryption scheme.

The client systems 2105 include a mobile client 2110 and a desktop client 2115 that serve as endpoints for initiating encryption and decryption operations within the secure attribute-based encryption system. The mobile client 2110 may execute lightweight cryptographic operations such as message preparation and ciphertext assembly, while leveraging the computational resources of the cloud services 2180 for intensive operations like trapdoor function evaluation and share generation. The desktop client 2115 may provide enhanced processing capabilities for local execution of encryption parameters generation and secret key management operations. Both the mobile client 2110 and desktop client 2115 connect to the network infrastructure 2220 through a local area network 2140, enabling secure communication with remote cryptographic services.

The network infrastructure 2220 facilitates secure data transmission between the client systems 2105 and the distributed computing resources through multiple network layers. A wide area network 2145 provides connectivity to geographically distributed server systems 2155 and cloud services 2180, enabling the secure attribute-based encryption system to operate across multiple data centers and computing regions. A content delivery network 2150 may cache frequently accessed public parameters such as the hash function H from the pairwise-independent hash family and the public key pk containing the set of trapdoor functions {g_{i,b}}_{i∈[n],b∈{0,1}}. The content delivery network 2150 reduces latency for encryption operations by providing geographically distributed access to these public cryptographic parameters.

The server systems 2155 provide dedicated computing resources for executing specific components of the secure attribute-based encryption system. An application server 2160 may host the encryption and decryption algorithms, managing the generation of shares(a_{1,0}, a_{1,1}, . . . , a_{n,0}, a_{n,1}) using the share generating algorithm and computing ciphertext components ct_{i,b}=g_{i,b}(a_{i,b}) for i∈[n] and b∈{0, 1}. A web server 2165 may provide user interfaces for attribute specification and message input, enabling users to submit messages m and attributes a for encryption operations. The web server 2165 may also serve as an endpoint for receiving complete ciphertext (ct₀, {ct_{i,b}}_{i∈[n],b∈{0,1}}) and presenting decrypted messages to authorized users.

A database server 2170 within the server systems 2155 may store cryptographic parameters, secret keys, and master secret keys in a secure manner. The database server 2170 may implement access control mechanisms that align with the attribute-based access control function F(x, ƒ), where decryption succeeds if and only if F(x, ƒ)=1. A storage server 2175 may provide persistent storage for ciphertext data and may implement distributed storage schemes that complement the secret sharing properties of the encryption system. The storage server 2175 may distribute ciphertext components across multiple storage nodes to enhance availability and fault tolerance.

The cloud services 2180 provide scalable computing resources for executing computationally intensive cryptographic operations. A load balancer 2185 distributes encryption and decryption requests across multiple computing instances within the cloud services 2180, enabling the system to handle varying workloads while maintaining consistent performance. The load balancer 2185 may implement intelligent routing algorithms that consider the computational complexity of different cryptographic operations, directing trapdoor function evaluations to appropriate computing resources based on their processing capabilities.

Cloud compute 2190 within the cloud services 2180 provides the computational infrastructure for executing the secure attribute-based encryption algorithms. Virtual machines 2195 within the cloud compute 2190 may host dedicated instances of the encryption and decryption processes, with each virtual machine configured to execute specific cryptographic operations such as trapdoor function generation or share reconstruction. The virtual machines 2195 may be dynamically provisioned based on the computational demands of the encryption system, scaling up during periods of high encryption activity and scaling down during periods of low utilization.

Container services 2200 within the cloud compute 2190 provide lightweight, portable execution environments for cryptographic algorithms. The container services 2200 may encapsulate the hash function sampling process, trapdoor function generation algorithms, and secret sharing implementations in isolated containers that can be deployed across multiple computing nodes. This containerized approach enables rapid deployment and scaling of cryptographic services while maintaining consistency across different computing environments. The container services 2200 may also facilitate the implementation of designated verifier non-interactive zero knowledge proofs by providing isolated execution environments for proof generation and verification processes.

Serverless functions 2205 within the cloud compute 2190 enable event-driven execution of specific cryptographic operations. The serverless functions 2205 may be triggered by encryption requests to execute operations such as random secret s sampling, final ciphertext component computation ct₀=m ⊕H(s), and integrity verification procedures. The serverless functions 2205 provide automatic scaling capabilities, instantiating additional function instances as encryption demand increases and terminating instances when demand decreases. This serverless architecture may reduce operational overhead while providing cost-effective execution of cryptographic operations.

An API gateway 2210 within the cloud services 2180 provides a unified interface for accessing the distributed cryptographic services. The API gateway 2210 may expose endpoints for encryption parameter generation, message encryption, ciphertext decryption, and proof verification operations. The API gateway 2210 may implement authentication and authorization mechanisms that integrate with the attribute-based access control properties of the encryption system, ensuring that users can access cryptographic services based on their attributes and associated permissions.

Cloud storage 2215 within the cloud services 2180 provides scalable storage for cryptographic data and parameters. The cloud storage 2215 may store public parameters such as the hash function H and public key pk, as well as encrypted data and associated metadata. The cloud storage 2215 may implement distributed storage schemes that align with the secret sharing properties of the encryption system, distributing ciphertext components across multiple storage locations to enhance security and availability.

Data flow services 2225 within the network architecture 2100 enable efficient processing and movement of cryptographic data across the distributed system. A message queue 2230 within the data flow services 2225 provides asynchronous communication between different components of the encryption system. The message queue 2230 may buffer encryption requests during periods of high demand, ensuring that cryptographic operations are processed in an orderly manner without overwhelming the computing resources. The message queue 2230 may also facilitate the coordination of multi-step cryptographic processes, such as the sequential execution of share generation, ciphertext component computation, and final ciphertext assembly.

Stream processing 2235 within the data flow services 2225 enables real-time processing of cryptographic operations as data flows through the system. The stream processing 2235 may process continuous streams of encryption requests, applying the secure attribute-based encryption algorithms to incoming messages and attributes in real-time. The stream processing 2235 may also implement real-time integrity verification by continuously monitoring the consistency of computed shares and ciphertext components as they are generated and transmitted through the system.

Batch processing 2240 within the data flow services 2225 enables efficient processing of large volumes of cryptographic operations. The batch processing 2240 may aggregate multiple encryption requests and process them collectively, optimizing resource utilization and reducing per-operation overhead. The batch processing 2240 may be particularly effective for operations such as trapdoor function generation, where multiple function pairs

$$( {g}_{i , b} , {g}_{i , b}^{- 1} )$$

can be generated simultaneously using parallel processing techniques.

An ETL pipeline 2245 within the data flow services 2225 provides extract, transform, and load capabilities for cryptographic data management. The ETL pipeline 2245 may extract cryptographic parameters and ciphertext data from various sources, transform the data to ensure compatibility with different components of the encryption system, and load the processed data into appropriate storage and computing resources. The ETL pipeline 2245 may also implement data validation procedures to ensure the integrity of cryptographic parameters and ciphertext components as they move through the distributed system.

The integration of these network architecture components enables the secure attribute-based encryption system to operate at scale across distributed computing environments while maintaining the security properties of the cryptographic algorithms. The distributed nature of the network architecture 2100 provides redundancy and fault tolerance, ensuring that cryptographic operations can continue even if individual components experience failures or performance degradation. Throughout this disclosure, various terms and phrases are used to describe features of the disclosed technology. It is to be understood that these terms and phrases may encompass a variety of meanings and definitions, as is common in the field of technology and patent law. The definitions of these terms may vary depending on the context in which they are used, the specific embodiment being described, or the interpretation of the technology by those skilled in the art.

In various embodiments, certain variable names, symbols, or labels may be used in the claims to represent various elements, components, or steps of the described methods, systems, and apparatuses. These variable names, symbols, or labels are provided for convenience and clarity in describing the claimed subject matter. However, it should be understood that the use of such variable names, symbols, or labels in the claims does not necessarily limit these elements, components, or steps to being the same specific entities described in the specification or in other parts of the disclosure. The variable names, symbols, or labels used in the claims should be interpreted broadly and may encompass various implementations, variations, or equivalents of the described elements, components, or steps, unless explicitly stated otherwise or clearly limited by the context of the claim. As such, the scope of the claims is not confined to the specific examples or embodiments described in the specification, but rather extends to the full breadth of the inventive concepts disclosed herein.

For instance, terms such as “computing device,” “processor,” “memory,” and “network” may refer to a wide range of devices, components, systems, and configurations known in the art, and their specific definitions may differ based on the implementation or design of the system. Similarly, phrases like “securely storing,” “computing a vector,” and “generating a message” may involve various methods, techniques, and processes that achieve the same or similar outcomes but may be executed in different manners.

It is also to be understood that the use of terms in the singular or plural form is not intended to limit the scope of the claims. For example, the mention of “a computing device” does not preclude the presence of multiple computing devices within a system. Likewise, references to “a network” may include various interconnected networks or a single network comprising multiple segments or layers.

Furthermore, the use of the term “may” in relation to an action or feature indicates that the action or feature is possible, but not necessarily mandatory. This term is used to describe optional or alternative aspects of the disclosed technology that provide flexibility in how the technology may be implemented or utilized.

The definitions provided herein are intended to serve as examples and are not exhaustive. Those skilled in the art may ascribe different meanings to these terms based on the context, the specific technology being described, or the advancements in the field. Therefore, the definitions of the terms and phrases used in this disclosure and the claims are to be interpreted broadly and in a manner consistent with the understanding of those skilled in the relevant art.

The use of the word “a” or “an” when used in conjunction with the claims herein is to be interpreted as including one or more than one of the element it introduces. Similarly, the use of the term “or” is intended to be inclusive, such that the phrase “A or B” is intended to include A, B, or both A and B, unless explicitly stated otherwise.

Reference throughout the specification to “one embodiment,” “another embodiment,” “an embodiment,” and so forth, means that a particular feature, structure, or characteristic described in connection with the embodiment is included in at least one embodiment of the present disclosure, and may not necessarily be present in all embodiments. Furthermore, the particular features, structures, or characteristics may be combined in any suitable manner in one or more embodiments without limitation.

The use of the terms “first,” “second,” and the like does not imply any order or sequence, but are used to distinguish one element from another, and the terms “top,” “bottom,” “front,” “back,” “leading,” “trailing,” and the like are used for descriptive purposes and are not necessarily to be construed as limiting.

As used herein, the term “processor” refers to any computing entity capable of executing instructions to perform a specific set of operations, whether implemented in hardware, firmware, software, or any combination thereof. This definition includes a broad range of processing technologies and architectures. The term encompasses general-purpose processors such as Central Processing Units (CPUs), specialized processors such as Graphics Processing Units (GPUs), as well as highly specialized hardware accelerators such as Neural Processing Units (NPUs) for artificial intelligence applications and Tensor Processing Units (TPUs) for machine learning workloads.

The term also encompasses reconfigurable computing architectures such as FieldProgrammable Gate Arrays (FPGAs) for applications requiring specialized processing configurations, Application-Specific Integrated Circuits (ASICs), Digital Signal Processors (DSPs), Systolic Array Processors, and emerging computing paradigms such as Quantum Processors that leverage principles of quantum mechanics. System on Chip (SoC) designs, heterogeneous computing systems, Edge Computing Processors for distributed network applications, cloud-based and distributed processors, multi-core and parallel processors, and Neuromorphic processors that draw inspiration from biological neural architectures are all encompassed within this definition.

The term “processor” also encompasses the associated memory hierarchies, including primary memory (such as RAM), secondary storage (such as hard drives and SSDs), and cache memory, which work in conjunction with the processor to store and retrieve data necessary for executing instructions. In this patent application, any reference to a“processor” should be interpreted broadly to include any type of processing unit capable of performing the described functions, regardless of its specific implementation, architecture, or physical form.

As used herein, the term “messages” may refer to any form of data or information that can be processed, transmitted, or stored in a digital format. Messages may include arbitrary-length plaintext messages, pre-hashed messages, concatenated messages, binary data, network protocol messages, database records, and time-stamped messages. Messages may be composed of characters, symbols, or binary data and may represent various forms of content such as text, numbers, multimedia, executable code, or any other data that can be digitally encoded. Messages may be used as input for cryptographic functions, such as keyed hash functions, where they are transformed into a fixed-size hash value influenced by a secret cryptographic key.

The term “messages” encompasses a wide range of data types and structures, from simple text strings to complex structured data, and may include metadata, headers, footers, or other information that facilitates the processing, transmission, or interpretation of the content. Messages may be generated by users, systems, or processes and may be intended for various purposes, including communication, authentication, verification, logging, or any other function that involves the use of digital data.

Messages may also include data formats specific to artificial intelligence and machine learning applications, such as tensors, feature vectors, embeddings, model parameters, activation maps, training examples, and inference requests. In distributed and edge computing contexts, the term “messages” further extends to include event streams, state updates, service requests, synchronization messages, and smart contract transactions used in blockchain platforms.

As used herein, the terms “store,” “storing,” “storage,” or variants thereof refer to any means, methods, systems, or processes for recording, retaining, or preserving data in a retrievable format. This terminology encompasses a broad spectrum of technologies and mechanisms that may be employed to maintain information for future access or reference.

The term “storing” or “storage” as used in this specification may encompass both persistent and transient data retention. In some cases, the storage may be entirely ephemeral, lasting only for the duration of a specific operation or process. The use of these terms does not imply any particular time period for data retention or any level of permanence. Storage and storing may be as brief as a few microseconds or indefinitely long, depending on the specific implementation and requirements of the system.

The term includes traditional electronic storage technologies such as magnetic storage (including hard disk drives, magnetic tape, and floppy disks), optical storage (including optical discs, holographic storage, and optical tape), and solid-state storage (including solid-state drives, flash memory, static random-access memory, dynamic random-access memory, and read-only memory). It also encompasses emerging storage technologies such as DNA storage, molecular storage, quantum storage, and photonic storage.

Storage terminology may refer to various architectural organizations and hierarchies of data repositories. This includes primary storage (main memory, cache memory) designed for rapid access during processing operations; secondary storage providing non-volatile retention of larger data volumes; and tertiary storage for archival purposes. The terminology extends to distributed storage architectures such as network-attached storage

(NAS), storage area networks (SAN), direct-attached storage (DAS), and object storage systems. It also includes cloud-based storage configurations, including public, private, and hybrid cloud storage implementations; edge storage systems located at network peripheries; and fog storage systems distributed between centralized and edge locations.

The definition encompasses storage virtualization technologies that abstract physical storage resources and present them as logical storage units, including virtual disks, software-defined storage, and storage hypervisors. It also includes storage orchestration systems that manage data placement, replication, and migration across distributed infrastructures.

The terminology extends to various data organization and management paradigms. This includes file systems that organize data into files and directories; block storage systems that manage data as fixed-sized blocks; object storage systems that handle data as discrete objects with metadata; and content-addressable storage systems that retrieve data based on content rather than location. It also includes specialized storage structures such as databases, data lakes, data warehouses, and knowledge repositories.

Storage terminology encompasses various operational characteristics and capabilities of storage systems. This includes persistent storage that maintains data integrity across power cycles; volatile storage that requires continuous power to retain data; and nonvolatile storage that preserves data without power. It also includes immutable storage that prevents modification of stored data; append-only storage that allows additions but not modifications; and version-controlled storage that maintains historical states of data. The term further encompasses encrypted storage that protects data confidentiality; redundant storage that duplicates data to prevent loss; and resilient storage that maintains availability despite component failures.

In specialized computing contexts, storage terminology may refer to domain-specific storage mechanisms. For blockchain and distributed ledger technologies, this includes on-chain storage within the blockchain itself and off-chain storage that maintains references to externally stored data. For neural networks and artificial intelligence systems, it includes weight storage for maintaining learned parameters and activation storage for intermediate computational results. For quantum computing systems, it refers to quantum state storage that preserves quantum information, while for edge computing, it includes transient storage for temporary data processing at network boundaries.

The term “storage” also encompasses the protocols, interfaces, and access methods used to interact with stored data. This includes file access protocols (such as NFS, SMB, and HDFS), block access protocols (such as iSCSI, Fibre Channel, and ATA), and object access protocols (such as S3, Swift, and CDMI). It also includes direct memory access mechanisms, memory-mapped file interfaces, and storage controller interfaces.

The term “database” should be construed to mean a blockchain, distributed ledger technology, key-value store, document-oriented database, graph database, time-series database, in-memory database, columnar database, object-oriented database, hierarchical database, network database, or any other structured data storage system capable of storing and retrieving information. This may include traditional relational database management systems (RDBMS), NoS [symbol] L databases, NewS [symbol] L databases, or hybrid database systems that combine multiple database paradigms. The database may be centralized, distributed, or decentralized, and may employ various data models, indexing strategies, and query languages to organize and access the stored information. It may also incorporate features such as ACID (Atomicity, Consistency, Isolation, Durability) compliance, eventual consistency, sharding, replication, or partitioning to ensure data integrity, availability, and scalability. The database may be hosted on-premises, in the cloud, or in a hybrid environment, and may support various access methods including direct queries, API calls, or event-driven architectures.

The term “database” further encompasses specialized data storage and management systems designed for particular domains or use cases. This includes blockchain and distributed ledger technologies used for secure, decentralized transaction records, edge databases optimized for resource-constrained environments, vector databases for highdimensional data, time-series databases for temporal data management, knowledge graphs for representing interconnected information, federated databases for integrating autonomous systems, and emerging paradigms such as quantum databases that leverage quantum computing principles.

The terms “connected,” “coupled,” or any variant thereof, mean any direct or indirect connection or coupling between two or more elements, and may encompass the presence of one or more intermediate elements between the two elements that are connected or coupled to each other.

In the context of modern computing architectures and network topologies, these terms may also refer to various connection modalities. This includes physical connections through wired or wireless interfaces, logical connections operating independently of the physical layer, API connections allowing software components to communicate, and microservice connections in distributed architectures. The terminology extends to edge-to-cloud connections for distributed processing environments, blockchain connections for distributed ledger systems, quantum connections for secure communication, and neural network connections for artificial intelligence systems.

As used herein, the term “display” or “displaying” refers to any means, method, apparatus, or process for visually presenting or otherwise conveying information to a user. This terminology encompasses a broad spectrum of technologies and presentation modalities that may be employed to render content perceivable by a user. The term includes traditional display technologies such as cathode ray tubes (CRTs), liquid crystal displays (LCDs), light-emitting diode (LED) displays, organic light-emitting diode (OLED) displays, micro-LED displays, and electronic paper displays. It also encompasses specialized display types such as transparent displays, flexible displays, foldable displays, stretchable displays, and holographic displays.

The term “display” may also refer to projection systems, including traditional projectors, laser projectors, pico projectors, and holographic projection systems. It further includes immersive display technologies such as head-mounted displays (HMDs), virtual reality (VR) headsets, augmented reality (AR) glasses, mixed reality (MR) systems, and smart contact lenses. The terminology extends to ambient display methods that integrate visual information into the environment, such as smart mirrors, interactive surfaces, projection mapping systems, and volumetric displays.

The definition also encompasses non-visual display modalities that may complement or substitute for visual displays. This includes auditory displays such as speech output systems, sonification interfaces, and spatial audio; haptic displays that communicate through tactile feedback, vibration patterns, or force feedback; and other sensory output mechanisms such as olfactory displays and thermotactile interfaces. Multimodal displays that combine multiple sensory channels for information presentation are also included within this terminology.

The term “display” further encompasses the software and computational components involved in rendering information. This includes rendering engines, graphics processing pipelines, display servers, and compositing systems. It also includes specialized display rendering techniques such as rasterization, ray tracing, vector graphics, procedural generation, and neural rendering. The term extends to user interface paradigms such as graphical user interfaces (GUIs), natural user interfaces (NUIs), voice user interfaces (VUIs), brain-computer interfaces (BCIs), and ambient intelligence systems.

In the context of accessibility, the term “display” includes assistive technologies and alternative display methods designed to accommodate diverse user needs. This encompasses screen readers, braille displays, audio descriptions, high-contrast modes, colorshifted presentations, and other adaptive display mechanisms. The terminology also includes display personalization techniques such as adaptive interfaces, contextual displays, and user-specific rendering optimizations.

The description of the embodiments of the present disclosure is intended to be illustrative, and not to limit the scope of the claims. Many alternatives, modifications, and variations will be apparent to those skilled in the art. A number of implementations have been described. Nevertheless, it will be understood that various modifications may be made without departing from the spirit and scope of the disclosure. Accordingly, other implementations are within the scope of the following claims.

1. A method for secure attribute-based encryption with function hiding properties, comprising:
(a) generating encryption parameters using a processor by:
(i) sampling a hash function H from a pairwise-independent hash family as a public parameter and storing the hash function H in a memory;
(ii) generating a sequence of trapdoor function pairs
$$( {g}_{i , b} , {g}_{i , b}^{- 1} )$$
b∈{0,1}, where n is a positive integer, and storing the trapdoor function pairs in the memory;
(iii) setting a public key pk as the set of trapdoor functions {g_{i,b}}_{i∈[n],b∈{0,1}} and storing the public key pk in the memory;
(iv) generating a secret key sk comprising a binary string ƒ of length n and a set of trapdoor function inverses
$${\{ {g}_{i , {f}_{i}}^{- 1} \}}_{i ∈ [ n ]} ,$$
where ƒᵢ is the i-th bit of ƒ, and storing the secret key sk in the memory; and
(v) storing remaining trapdoor function inverses as a master secret key in a memory;
(b) receiving, via a network interface device, a message m to be encrypted and an attribute x, and storing the message m and the attribute a in the memory;
(c) encrypting the message m under the attribute a using the processor by:
(i) sampling a random secret s and storing the random secret s in the memory;
(ii) generating shares (a_{1,0}, a_{1,1}, . . . , a_{n,0}, a_{n,1}) using a share generating algorithm executed by the processor and storing the generated shares in the memory;
(iii) computing ciphertext components ct_{i,b}=g_{i,b}(a_{i,b}) for i∈[n] and b∈{0, 1} using the processor and storing the ciphertext components in the memory; and
(iv) computing a final ciphertext component ct₀=m ⊕H(s), where ⊕ denotes bitwise XOR, and storing the final ciphertext component in the memory;
(d) assembling, using the processor, a complete ciphertext as (ct₀, {ctᵢ}_{i∈[n],b∈{0,1}}) and storing the complete ciphertext in a storage device; and
(e) transmitting the complete ciphertext via the network interface device.

2. The method of claim 1, further comprising decrypting the complete ciphertext by:
computing shares
$${a}_{i , {f}_{i}} = {g}_{i , {f}_{i}}^{- 1} ( {ct}_{i , {f}_{i}} ) for all {g}_{i , {f}_{i}}^{- 1} ∈ sk ;$$
(ii) reconstructing the secret s using a secret sharing reconstruction procedure on the computed shares; and
(iii) recovering the message as m=ct₀⊕H(s).

3. The method of claim 1, further comprising implementing function hiding properties, wherein an adversary with access to the complete ciphertext and the message cannot distinguish between two different implementations of encryption functions that produce the same input-output behavior.

4. The method of claim 1, further comprising executing a transformation to construct a designated verifier non-interactive zero knowledge proof, wherein one or more of the following properties are satisfied:
(a) the proof is designated for a specific verifier with a secret verification key;
(b) the proof consists of a single message from the prover to the designated verifier;
(c) the proof demonstrates knowledge of a witness for a statement without revealing any information about the witness beyond its existence;
(d) only the designated verifier possessing the secret verification key can validate the proof;
(e) the proof cannot be re-used or transferred to convince any other party of the statement's validity;
(ƒ) the designated verifier cannot use the proof to convince others, maintaining zero-knowledge even if the verifier is malicious; or
(g) the transformation ensures that the resulting proof preserves the security properties of the original attribute-based encryption scheme while adding the designated verifier property.

5. The method of claim 1, wherein the trapdoor function pairs
$$( {g}_{i , b} , {g}_{i , b}^{- 1} )$$
are generated using a lossy trapdoor function setup algorithm that ensures the trapdoor functions can be sampled efficiently in either a lossy or injective mode, and wherein the trapdoor function pairs
$$( {g}_{i , b} , {g}_{i , b}^{- 1} )$$
are efficiently computable and invertible in the injective mode with knowledge of the trapdoor.

6. The method of claim 1, wherein the share generating algorithm implements a secret sharing scheme for non-monotone functions, allowing reconstruction of the secret s from an authorized subset of the shares, and wherein the pairwise-independent hash family is selected to ensure that the entropy of the random secret s given the ciphertext components is sufficiently high to prevent statistical attacks.

7. The method of claim 2, further comprising verifying the integrity of the computed shares by:
(a) regenerating all the shares using the reconstructed secret s;
(b) applying the trapdoor functions g_{i,b} to the regenerated shares; and
(c) comparing the results with the original ciphertext components ct_{i,b}.

8. The method of claim 1, wherein the attribute x and the binary string ƒ represent inputs to a function F(x, ƒ), and decryption succeeds if and only if F(x, ƒ)=1, thereby implementing attribute-based access control.

9. A system for secure attribute-based encryption with function hiding properties, comprising:
(a) a processor; and
(b) a memory storing instructions that, when executed by the processor, cause the system to perform operations comprising:
(i) generating encryption parameters by:
(A) sampling a hash function H from a pairwise-independent hash family as a public parameter and storing the hash function H in the memory;
(B) generating a sequence of trapdoor function pairs
$$( {g}_{i , b} , {g}_{i , b}^{- 1} )$$
for i∈[n] and b∈{0, 1}, where n is a positive integer, and storing the trapdoor function pairs in the memory;
(C) setting a public key pk as the set of trapdoor functions {g_{i,b}}_{i∈[n],b∈{0,1}} and storing the public key pk in the memory;
(D) generating a secret key sk comprising a binary string ƒ of length n and a set of trapdoor function inverses
$${\{ {g}_{i , {f}_{i}}^{- 1} \}}_{i ∈ [ n ]} ,$$
where ƒᵢ is the i-th bit of ƒ, and storing the secret key sk in the memory; and
(E) storing remaining trapdoor function inverses as a master secret key in the memory;
(ii) receiving, via a network interface device, a message m to be encrypted and an attribute x, and storing the message m and the attribute a in the memory;
(iii) encrypting the message m under the attribute a by:
(A) sampling a random secret s and storing the random secret s in the memory;
(B) generating shares (a_{1,0}, a_{1,1}, . . . , a_{n,0}, a_{n,1}) using a share generating algorithm and storing the generated shares in the memory;
(C) computing ciphertext components ct_{i,b}=g_{i,b}(a_{i,b}) for i∈[n] and b∈{0,1} and storing the ciphertext components in the memory; and
(D) computing a final ciphertext component ct₀=m ⊕H(s), where ⊕ denotes bitwise XOR, and storing the final ciphertext component in the memory;
(iv) assembling a complete ciphertext as (ct₀, {ct_{i,b}}_{i∈[n],b∈{0,1}}) and storing the complete ciphertext in a storage device; and
(v) transmitting the complete ciphertext via the network interface device.

10. The system of claim 9, wherein the operations further comprise decrypting the complete ciphertext by:
(i) computing shares
$${a}_{i , {f}_{i}} = {g}_{i , {f}_{i}}^{- 1} ( {ct}_{i , {f}_{i}} ) for all {g}_{i , {f}_{i}}^{- 1} ∈ sk ;$$
(ii) reconstructing the secret s using a secret sharing reconstruction procedure on the computed shares; and
(iii) recovering the message as m=ct₀⊕H(s).

11. The system of claim 9, wherein the operations further comprise implementing function hiding properties, wherein an adversary with access to the complete ciphertext and the message cannot distinguish between two different implementations of encryption functions that produce the same input-output behavior.

12. The system of claim 9, wherein the operations further comprise executing a transformation to construct a designated verifier non-interactive zero knowledge proof, wherein one or more of the following properties are satisfied:
(a) the proof is designated for a specific verifier with a secret verification key;
(b) the proof consists of a single message from the prover to the designated verifier;
(c) the proof demonstrates knowledge of a witness for a statement without revealing any information about the witness beyond its existence;
(d) only the designated verifier possessing the secret verification key can validate the proof;
(e) the proof cannot be re-used or transferred to convince any other party of the statement's validity;
(f) the designated verifier cannot use the proof to convince others, maintaining zero-knowledge even if the verifier is malicious; or
(g) the transformation ensures that the resulting proof preserves the security properties of the original attribute-based encryption scheme while adding the designated verifier property.

13. The system of claim 9, wherein the trapdoor function pairs
$$( {g}_{i , b} , {g}_{i , b}^{- 1} )$$
are generated using a lossy trapdoor function setup algorithm that ensures the trapdoor functions can be sampled efficiently in either a lossy or injective mode, and wherein the trapdoor function pairs
$$( {g}_{i , b} , {g}_{i , b}^{- 1} )$$
are efficiently computable and invertible in the injective mode with knowledge of the trapdoor.

14. The system of claim 9, wherein the share generating algorithm implements a secret sharing scheme for non-monotone functions, allowing reconstruction of the secret s from an authorized subset of the shares, and wherein the pairwise-independent hash family is selected to ensure that the entropy of the random secret s given the ciphertext components is sufficiently high to prevent statistical attacks.

15. The system of claim 10, wherein the operations further comprise verifying the integrity of the computed shares by:
(a) regenerating all the shares using the reconstructed secret s;
(b) applying the trapdoor functions g_{i,b} to the regenerated shares; and
(c) comparing the results with the original ciphertext components ct_{i,b}.

16. The system of claim 9, wherein the attribute a and the binary string ƒ represent inputs to a function F(x, ƒ), and decryption succeeds if and only if F(x, ƒ)=1, thereby implementing attribute-based access control.

17. A non-transitory computer-readable storage medium storing instructions that, when executed by a processor, cause the processor to perform operations for secure attribute-based encryption with function hiding properties, the operations comprising:
(a) generating encryption parameters by:
(i) sampling a hash function H from a pairwise-independent hash family as a public parameter and storing the hash function H in a memory;
(ii) generating a sequence of trapdoor function pairs
$$( {g}_{i , b} , {g}_{i , b}^{- 1} )$$
for i∈[n] and b∈{0, 1}, where n is a positive integer, and storing the trapdoor function pairs in the memory;
(iii) setting a public key pk as the set of trapdoor functions {g_{i,b}}_{i∈[n],b∈{0,1}} and storing the public key pk in the memory;
(iv) generating a secret key sk comprising a binary string ƒ of length n and a set of trapdoor function inverses
$${\{ {g}_{i , {f}_{i}}^{- 1} \}}_{i ∈ [ n ]} ,$$
where ƒᵢ to one on one of ƒ, and storing the secret key sk in the memory; and
(v) storing remaining trapdoor function inverses as a master secret key in a memory;
(b) receiving, via a network interface device, a message m to be encrypted and an attribute x, and storing the message m and the attribute a in the memory;
(c) encrypting the message m under the attribute a using the processor by:
(i) sampling a random secret s and storing the random secret s in the memory;
(ii) generating shares (a_{1,0}, a_{1,1}, . . . , a_{n,0}, a_{n,1}) using a share generating algorithm executed by the processor and storing the generated shares in the memory;
(iii) computing ciphertext components ct_{i,b}=g_{i,b}(a_{i,b}) for i∈[n] and b∈{0, 1} using the processor and storing the ciphertext components in the memory; and
(iv) computing a final ciphertext component ct₀=m⊕H(s), where ⊕ denotes bitwise XOR, and storing the final ciphertext component in the memory;
(d) assembling, using the processor, a complete ciphertext as (ct₀, {ct_{i,b}}_{i∈[n],b∈{0,1}}) and storing the complete ciphertext in a storage device; and
(e) transmitting the complete ciphertext via the network interface device.

18. The non-transitory computer-readable storage medium of claim 17, wherein the operations further comprise decrypting the complete ciphertext by:
(i) computing shares
$${a}_{i , {f}_{i}} = {g}_{i , {f}_{i}}^{- 1} ( {ct}_{i , {f}_{i}} ) for all {g}_{i , {f}_{i}}^{- 1} ∈ sk ;$$
(ii) reconstructing the secret s using a secret sharing reconstruction procedure on the computed shares; and
(iii) recovering the message as m=ct₀⊕H(s).

19. The non-transitory computer-readable storage medium of claim 17, wherein the operations further comprise executing a transformation to construct a designated verifier non-interactive zero knowledge proof, wherein one or more of the following properties are satisfied:
(a) the proof is designated for a specific verifier with a secret verification key;
(b) the proof consists of a single message from the prover to the designated verifier;
(c) the proof demonstrates knowledge of a witness for a statement without revealing any information about the witness beyond its existence;
(d) only the designated verifier possessing the secret verification key can validate the proof;
(e) the proof cannot be re-used or transferred to convince any other party of the statement's validity;
(f) the designated verifier cannot use the proof to convince others, maintaining zero-knowledge even if the verifier is malicious; or
(g) the transformation ensures that the resulting proof preserves the security properties of the original attribute-based encryption scheme while adding the designated verifier property.

20. The non-transitory computer-readable storage medium of claim 17, wherein the trapdoor function pairs
$$( {g}_{i , b} , {g}_{i , b}^{- 1} )$$
are genterated using a messy trapdoor function setup algorithm that ensures the trapdoor functions can be sampled efficiently in either a lossy or injective mode, wherein the trapdoor function pairs
$$( {g}_{i , b} , {g}_{i , b}^{- 1} )$$
are efficiently computable and invertible in the injective mode with knowledge of the trapdoor, wherein the share generating algorithm implements a secret sharing scheme for non-monotone functions, allowing reconstruction of the secret s from an authorized subset of the shares, and wherein the attribute x and the binary string ƒ represent inputs to a function F(x, ƒ), and decryption succeeds if and only if F(x, ƒ)=1, thereby implementing attribute-based access control.
